(19) United States
(12) Patent Application Publication
(10) Pub. No.: US 2015/0056578 A1
(43) Pub. Date: Feb. 26, 2015

(54) METHODS AND SYSTEMS FOR GAMIFIED PRODUCTIVITY ENHANCING SYSTEMS

(71) Applicant: ADP, LLC, Roseland, NJ (US)

(72) Inventors: Susan Olenick, Hillsborough, NJ (US); Helene Jeiven, Scotch Plains, NJ (US); Osaze Eke, Hiawatha, NJ (US); LaMont Boykins, Parsippany, NJ (US)

(73) Assignee: ADP, LLC, Roseland, NJ (US)

(21) Appl. No.: 14/463,191

(22) Filed: Aug. 19, 2014

Related U.S. Application Data
(60) Provisional application No. 61/868,989, filed on Aug. 22, 2013.

(51) Int. Cl. G09B 9/00; G09B 19/18

(52) U.S. Cl. CPC G09B 9/00; G09B 19/18
USPC 434/108; 434/107

(57) ABSTRACT

Systems and methods for a gamified Productivity Enhancing System.

### CROSS-REFERENCE TO RELATED APPLICATIONS

The present application is a non-provisional application claiming priority to U.S. Provisional Patent Application No. 61/868,989 filed Aug. 22, 2013, entitled “METHODS AND SYSTEMS FOR GAMIFIED PRODUCTIVITY ENHANCING SYSTEMS”, the entirety of which is incorporated by reference herein.

### FIELD OF DISCLOSURE

The subject matter of the present invention generally includes productivity enhancing systems that increase client engagement, motivation, and reinforce learning.

### BACKGROUND OF THE DISCLOSURE

Productivity enhancing systems (“PES”) are replete in sophisticated commercial enterprises. PES are applications developed to enhance productivity by decreasing costs, increasing work output, or creating a better quality of life for employees. Users of these systems are often called upon to master various different applications. Training lessons are developed by Instructional Designers, administered by trainers, and administered to trainees. Training lessons are designed to prepare trainees to competently operate the PES. It is a goal of Instructional Designers to develop PES that increases client engagement, motivation, and reinforce learning.

### SUMMARY

Gamification is the addition of game elements, such as reward points, achievement badges, trophies, levels, leader boards, and progress indicators, to non-game activities. The goal is to engage players, motivate them, develop their skills, and reinforce learning. Described herein are exemplary embodiments of systems and methods for adding gamification to system training challenges for PES. An example of PES includes: Human Capital Management, such as training for business applications, payroll services, talent management, human resources management, benefits administration, and time and attendance management. Business applications refer to applications that are used in the performance of everyday or routine work for an enterprise, for example, applications where the competence in using the application is required for job performance and greater proficiency in such applications translate into increased productivity. Examples of such business applications include, for example, banking and/or transaction processing systems and software, retail sales systems and software, data entry and data processing systems and software, Office systems and software (e.g. Microsoft Office and associated programs such as Microsoft Word, Excel, PowerPoint, Outlook, etc; OpenOffice and associated programs, etc.), time entry systems and software, payroll processing systems and software, electronic document and imaging management systems and software, and so on.

Exemplary advantages of the application of gamification to system training challenges are increased user engagement, motivation, and reinforced learning. Additionally, analyses of gamified training challenges (GTC) user results enables system instructional designers to evaluate the efficiency and effectiveness of training challenges and lessons via real time observation of participant success or failure. Third, analyses of the results of GTC provide product developers with feedback critical to improving the PES as well as the business applications.

Described in embodiments of PES are gamification techniques to create training challenges. The training challenges are designed to measure how trainees (players) complete a series of progressively difficult scenarios (e.g., “Levels”), either during or after training sessions. Upon completion of the gamified training challenges a user's scores may be analyzed, and the results can be evaluated by the trainees, instructional designer, or product developer. Additionally, multiple users; scored can be also be analyzed be evaluated by the trainee, instructional designer, or product developer.

The details of one or more of embodiments of the invention are set forth in the accompanying descriptions below. The foregoing is not intended to summarize each potential embodiment or every aspect of the disclosure.

The present application discloses a system for providing a productivity enhancing interactive training simulation. The system comprises a computing device including an processor and program memory storing instructions that, when executed, cause the computing device to at least: provide a training platform to allow one or more users to access a gamified interactive training simulation; establish a user profile for a user; provide the user with the gamified interactive training simulation for a Graphic User Interface (“GUI”), the training simulation including at least one challenge task, each challenge task including a plurality of actions requiring correct data input for each action for the challenge task to be completed successfully, wherein challenge task includes actions for training a user to use a business application; record entry input data entered by the users for the actions; store the entry data in a training data database; and score the users based on correct entries of the users.

Specifically, in an embodiment, the training simulation includes one or more virtual characters in a virtual business setting to guide the user in the interactive training simulation.

According to another embodiment, the system is configured to detect a first incorrect entry for an action and display first instructive information indicating the entry is incorrect, and detect a second incorrect entry for the same action and display second instructive information that directs the users to a correct entry.

According to another embodiment, the system is further configured to at least display, when the second incorrect entry is located at an area on the GUI display that leads to a particular simulation result, the particular simulation result prior to displaying the second instructive information which directs the users to the correct entry.

According to another embodiment, the system is further configured to at least only score a first correct entry for each action.

According to another embodiment, the system is further configured to at least display a badge icon for indicating the score awarded to each of the users for each of the challenge tasks completed by the users.

According to another embodiment, the system is further configured to at least display a trophy when the users complete the challenge tasks for each of one or more training levels.

According to another embodiment, the system comprises a web based interface accessed by the users through a network to access the gamified interactive training simulation.

According to another embodiment, the system is further configured to at least calculate and display a total score of each of the users by adding up the awarded score for each of the challenge tasks.

According to another embodiment, the system is further configured to at least award and display a plaque to a user with a total score higher than a predetermined requirement.

According to another embodiment, information provided by the one or more virtual characters is displayed in bubble dialogue boxes.

According to another embodiment, the interactive interface comprising gaming elements further comprises: a progress bar, a reset button to retake the challenge tasks, a level indicator, and a progress gauge.

According to another embodiment, the system is further configured to at least when the users click a reset button, reset a current score awarded for a current training level to zero and subtracted the zeroed score from the total score.

According to another embodiment, the input entry data is recorded and stored in one or more databases.

According to another embodiment, the system is further configured to provide gamified sound effects for user input entries.

According to another embodiment, the simulated product is configured for productivity enhancing systems (PES), comprising Human Capital Management (HCM) business applications for payroll services, talent management, human resources management, benefits administration, and time and attendance management.

According to another embodiment, the system is further configured to at least provide one ore more training levels associated with at least one challenge task, and assign a level to the user based on the score of each challenge task.

According to another embodiment, the system is further configured to at least generate a leaderboard based on the scores of the users, wherein the leaderboard is accessible for display to the users.

Embodiments also comprise an information processing method for adding gamification elements to simulated product for training and evaluating users comprising providing a training platform to allow one or more users access gamified interactive training simulation; establishing a user profile for a user; providing the user with the gamified interactive training simulation for a Graphic User Interface (“GUI”), the training simulation including at least one challenge task, each challenge task including a plurality of actions requiring correct data input for each action for the challenge task to be completed successfully, wherein challenge task includes actions for training a user to use a business application; recording entry input data entered by the users for the actions; storing the entry data in a training data database; and scoring the users based on correct entries of the users.

Embodiments also comprise a non-transitory computer-readable recording medium for storing a computer program that when executed on a computer causes information processing, comprising providing a training platform to allow a plurality users of an organization to access gamified interactive training simulation; establishing a user profile for a user; providing the user with the gamified interactive training simulation for a Graphic User Interface (“GUI”), the training simulation including at least one challenge task, each challenge task including a plurality of actions requiring correct data input from a user for each action for the challenge task to be completed successfully, wherein challenge task includes actions for training a user to use a business application; recording entry input data entered by the users for the actions; storing the entry data in a training data database; and scoring the users based on correct entries of the users.

### BRIEF DESCRIPTION OF DRAWINGS

FIG. 1 illustrates an example of a system and network.

FIG. 2A illustrates a portion of an enrollment page of the gamified training platform presented to users according to an embodiment of the present disclosure.

FIG. 2B illustrates an interactive page for introducing challenge tasks of a particular level according to an embodiment of the present disclosure.

FIGS. 3A-3H illustrate an example of a series of interactive displays of a challenge task of a particular level of the gamified training platform presented to the users according to an embodiment of the present disclosure.

FIG. 4 illustrates a process for collecting input data as well as scoring the user's action according to an embodiment of the present disclosure.

FIGS. 5A-5O illustrate another example of a series of interactive displays of a challenge task of a particular level of the gamified training platform presented to the users according to an embodiment of the present disclosure.

FIG. 6 illustrates an example of an analysis result of the user's action within the gamified training platform according to an embodiment of the present disclosure.

FIG. 7 illustrates an example of an evaluation result of the gamified training platform according to an embodiment of the present disclosure.

FIG. 8 illustrates an exemplary structure of a server, system, or a terminal according to an embodiment.

### DETAILED DESCRIPTION OF EMBODIMENTS

It is to be understood that the figures and descriptions of the present embodiments of the invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

Disclosed are gamified training challenges useful to reinforce skills required to competently operate PES, for example, business applications. The application of gamification to training challenges for PES alleviates or mitigates several problems related to training and knowledge reinforcement. The gamified training challenges of the invention promote client engagement, motivation, and reinforce learning. The gamified challenges also allow instruction designers or system designers to gather valuable information regarding the effectiveness of their training challenges, and the overall design and implementation of the productivity enhancing systems. Moreover, the data gathered can be used not only to improve PES, but also to improve the business applications users are being trained to use.

Gamification involves additions or enhancements to training challenges that possess game-like features known to those in the art. For example, specific gamification embodiments may require the trainee to traverse levels of increasing difficulty, earn badges, increase progress bars, monitor a level indicator (beginner, experienced, or expert), or earn trophies. Sounds and graphic effects are also optional gamification effects.

Scoring is another tool for gamification. The scoring paradigm may be numerical or it may be by other scoring methodologies as known in gaming. Scoring can be tied to the award of badges or trophies, rewarding the trainee for correct answers, speed, etc. Scoring for a particular trainee may also be compared to other trainees and result in a particular trainee being identified on a leader board or recognized as the highest scorer. Scoring may also include assigning different scores when whether a trainee correctly performs a task on their first, second, or third attempt or based on the level of difficulty of each interaction.

In addition to scoring, trainee feedback from the gamification elements can also be employed. For example, in an embodiment, where a trainee is correct on their first try, no feedback is provided. However, if the first attempt is incorrect, feedback indicates only that the player made an incorrect input, and upon a second incorrect try, feedback directs the player to the correct entry so the player can move on. In some embodiments, if the player clicks a reasonable but incorrect location, the module may display the resulting screen and the player receives feedback that directs the player to the correct location. The type of feedback can be tailored to the gamified training challenges.

In an embodiment, tracking and reporting are also operatively employed or incorporated with a gamified training system. For example, the system can be configured with one or more modules that track all data inputs of a user via an interface, for example a Graphical User Interface (“GUI”), (for example the GUI objects clicked via mouse input or touchscreen or keystrokes via a keyboard) in each task of every activity and store and report the occurrences. The data inputs can be recorded and stored records which are kept in a training data database. The activity of each trainee can be analyzed individually or collectively. The tracking and reporting functions enhance the ability of trainers to evaluate their training module, and designers to assess the shortcomings and strengths of their productivity enhancement system as well as provide data on the applications the trainees are being trained on.

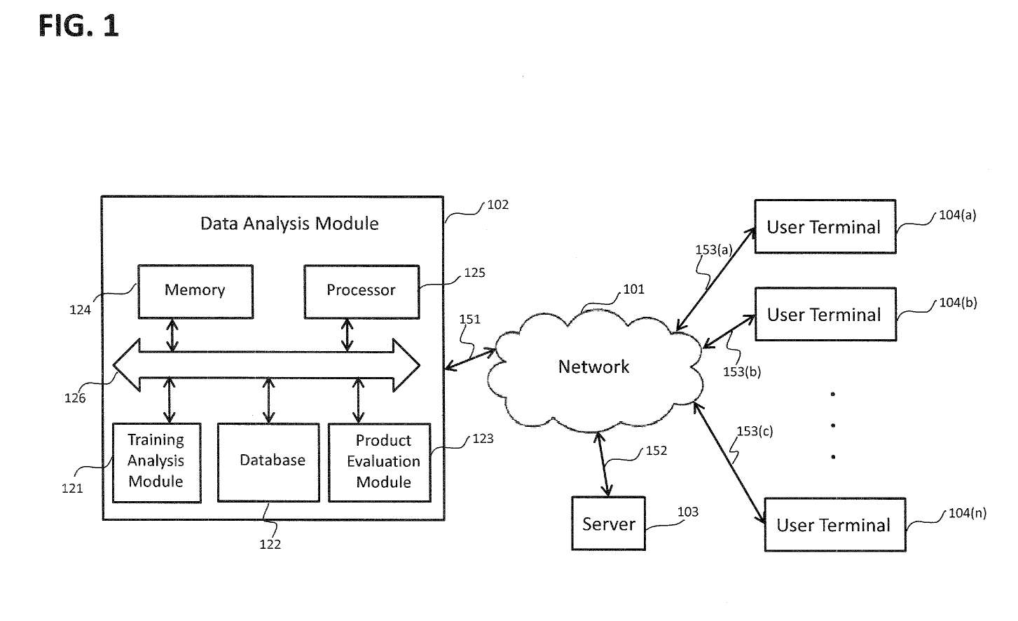

FIG. 1 illustrates an example of a system that supports embodiments of the present invention. The system includes a network 101, a data analysis module 102, a server 103, and one or more user terminals 104(a), 104(b) . . . 104(n) (where “n” is any suitable number).

The network 101 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The data analysis module 102 includes training analysis module 121, database 122, product evaluation module 123, memory 124 and processor 125. These elements, or modules, may be operatively coupled, for example by a bus 126. The modules, such as training analysis module 121 and product evaluation module 123 may be, for example, non-transitory electronic storage registers that operate in conjunction with a processor, such as 125, or other processors as shown and described herein to perform the function of the algorithm, or program code stored therein. The modules as described as stored in memory 124 are typically program code that execute instructions stored on a non-transitory, computer-readable medium and are software components that operate with hardware components.

The server module, or facility, or unit, 103 is typically one or more processors with associated memory, such as computers, or other processing devices such as a desktop computer, laptop computer, personal digital assistant (PDA), wireless handheld device, cellular telephone, or the like. The server module 103 is capable of processing and storing data or merely capable of accessing processed and stored data from another location (i.e., both thin and fat terminals).

User terminals 104(a) . . . (n) (generally referred to as 104, herein). The user terminals 104 typically include devices with processing capabilities and memory and an output displays, such as, laptop computers, desktop computers, cell phone, personal digital assistant (PDA), wireless handheld device and the like. The user terminals 104 may be capable of processing and storing and displaying data themselves or merely capable of accessing processed and stored data from another location (i.e., both thin and fat terminals) and displaying the accessed or retrieved data. It is also an embodiment of the present invention that the functionality of server 103 could also be part of server 103 and/or client device, or terminal 104.

Server module 103, data analysis module 102 and terminals 104 are coupled to network 101 via an associated bi-directional communication medium, 151, 152 and 153, respectively, which may be for example a serial bus such as IEEE 1394, or other wire or wireless transmission medium. The data analysis module 102, server module 103, and the user terminal 104 may be communication appliances, or user locations, or subscriber devices.

One or more servers 102, 103 can be configured to provide the PES gamified training simulation to a plurality to users via user terminals 104n as described herein.

Embodiments of the present invention may be implemented using one or more processing devices, or processing modules or components. The processing devices, or modules, or components may be coupled such that portions of the processing and/or data manipulation may be performed at one or more processing devices and shared or transmitted between a plurality of processing devices.

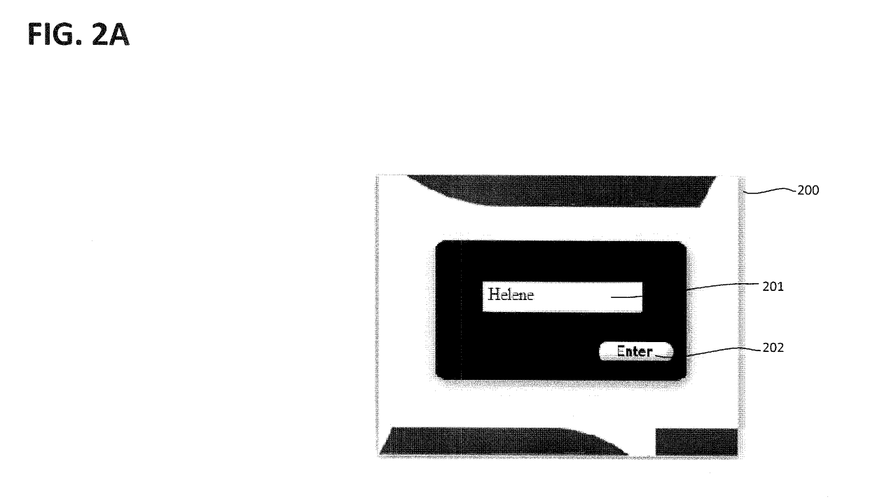

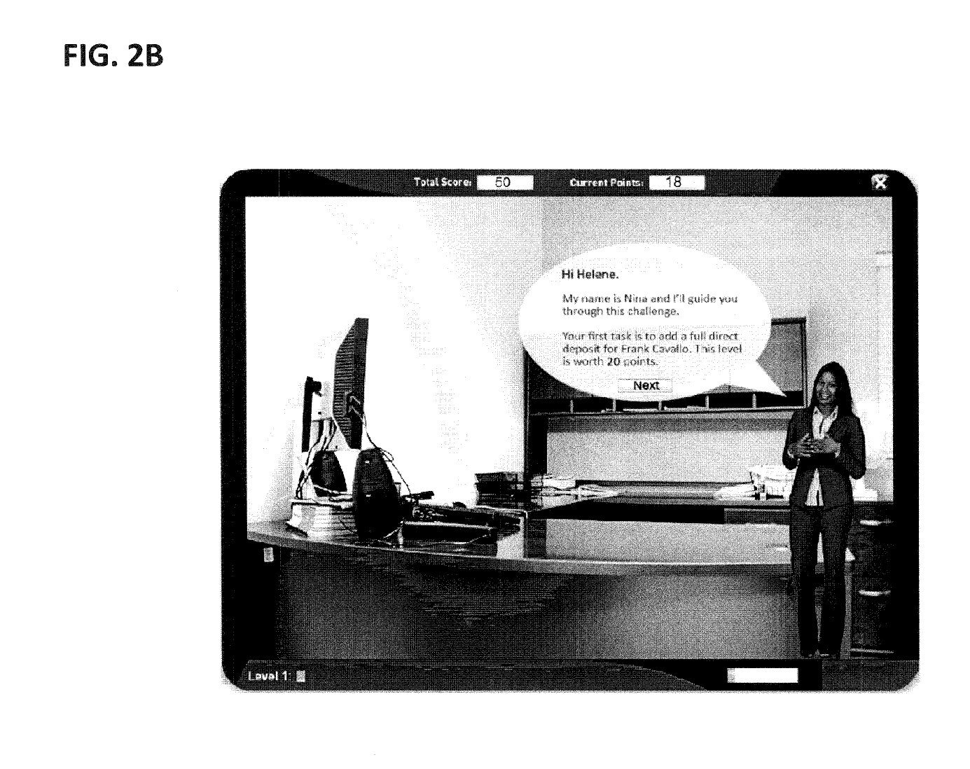

FIG. 2A illustrates a portion of an enrollment page of the gamified training platform presented to users at a user terminal according to an embodiment of the present disclosure, whereby the user establishes a user profile. As shown in the portion 200 of enrollment page presented on a GUI, the user may input a desired user name in the input box 201. After the desired name is input, the user may click “enter” button 202 via an input device, such as a mouse or touch screen. The user name selected by the user will be used during the training activities. For example, as shown in FIG. 2A, the user inputs a name “Helene,” which can, but need not, be a real name, if for example anonymity if preferred for competitive events or leader boards as described herein. As shown in FIG. 2B, a virtual instructor addresses the user by “Helene” in a dialogue box in an interactive page for introducing a challenge task for a level of the game. The virtual instructor may introduce each level and appear again throughout the level to provide the information needed to complete the scenario.

According to an embodiment, the training application may include a plurality of levels. The levels simulate the primary tasks required to complete a job function using a PES, and each level provides a series of actions that for a typical work-related scenario. The system can be configured to present progressively more challenging tasks that generate, on successful completion, greater scores and/or point values. Current score and total score can be calculated within each level.

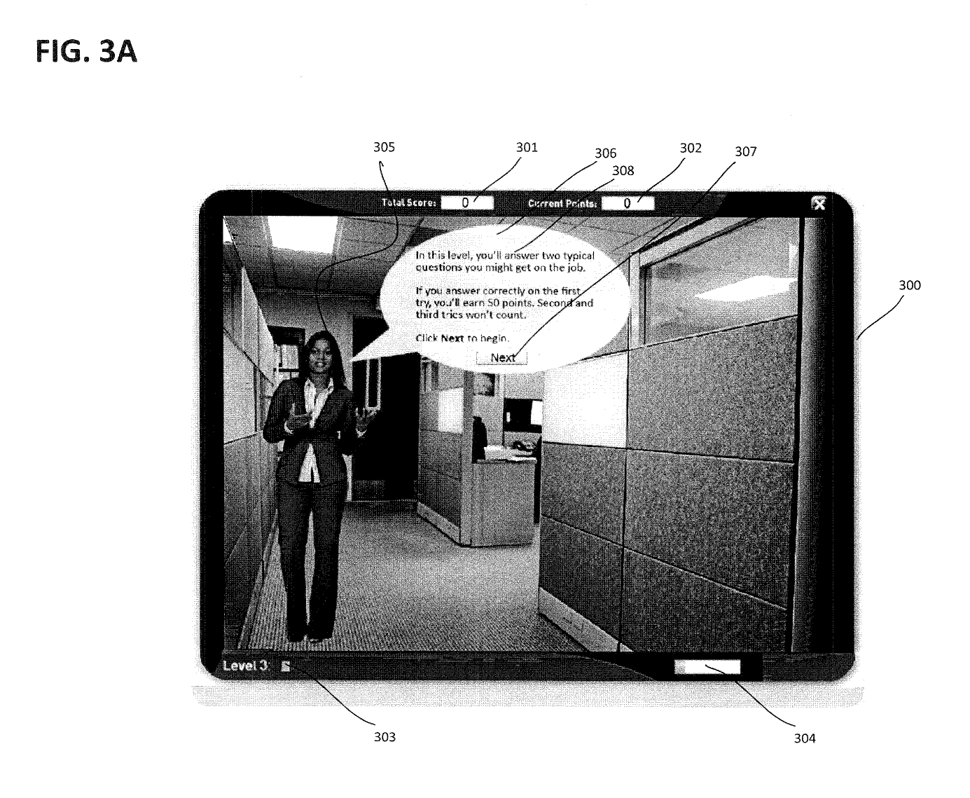

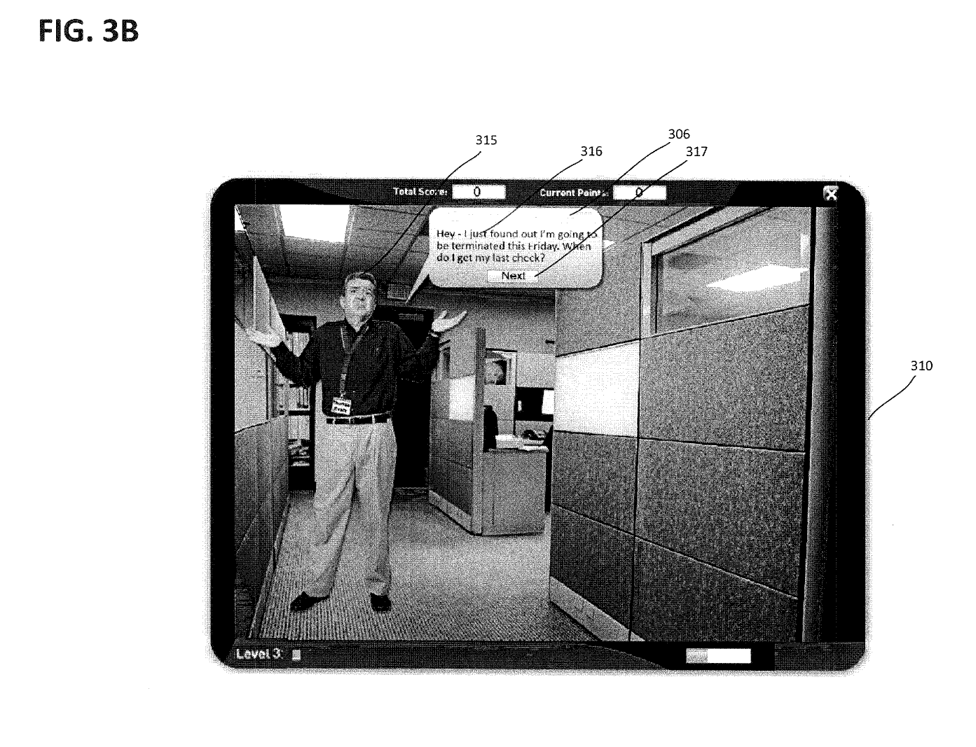

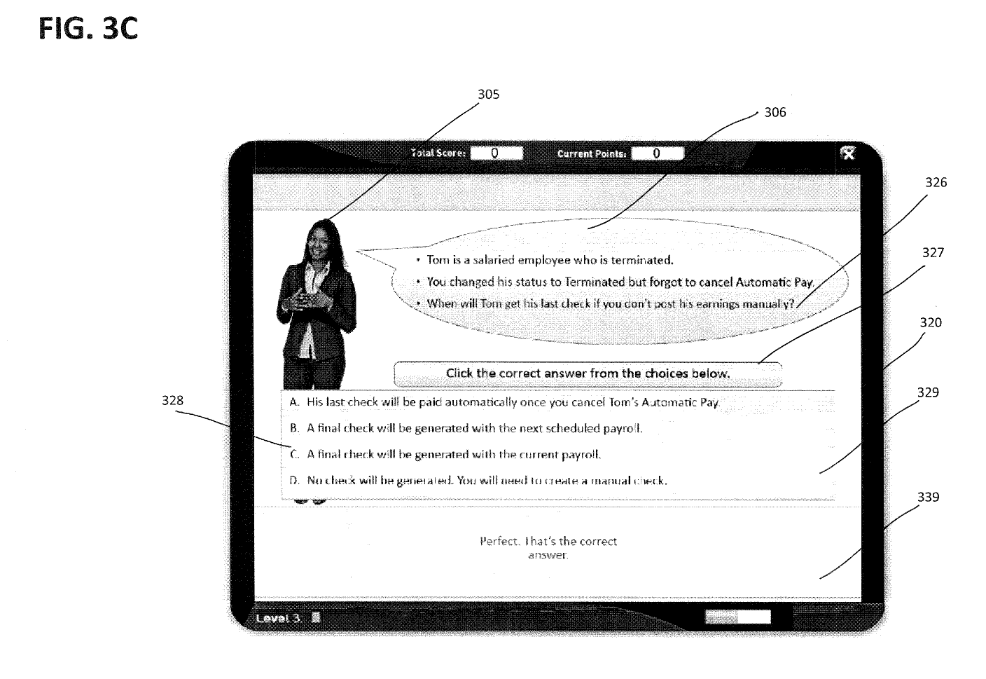

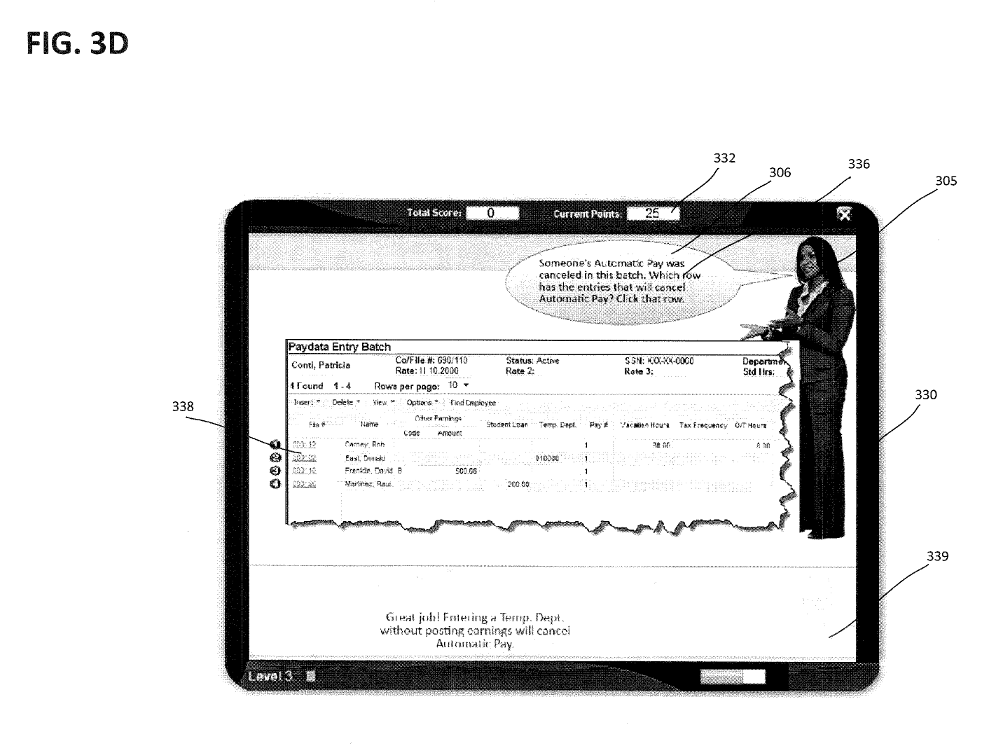

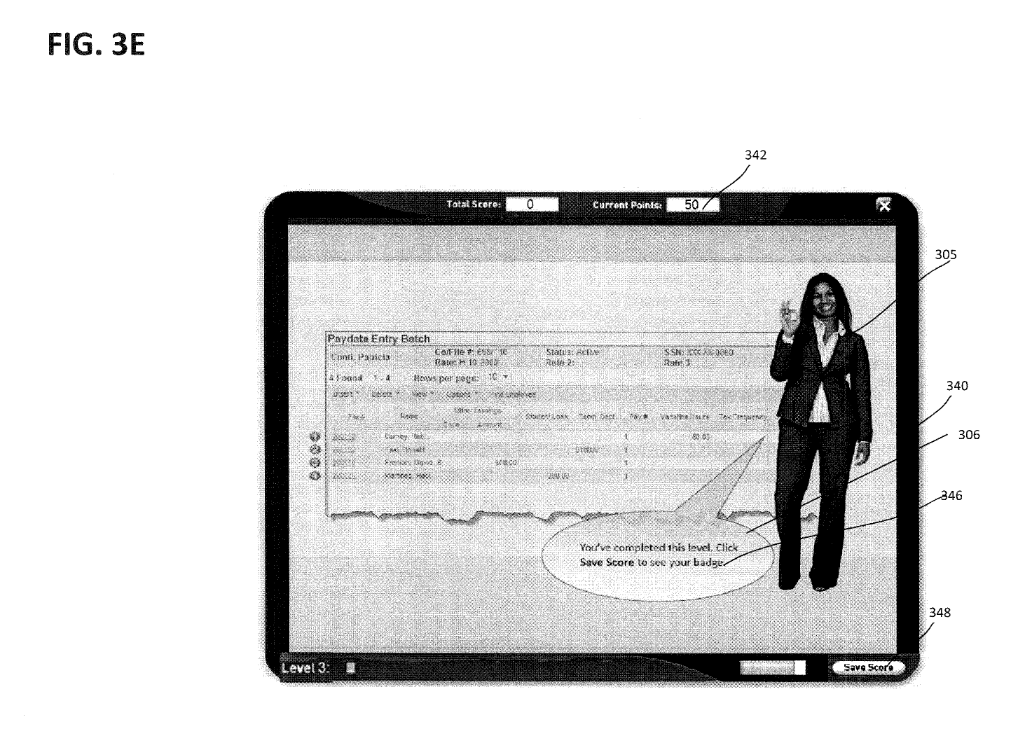

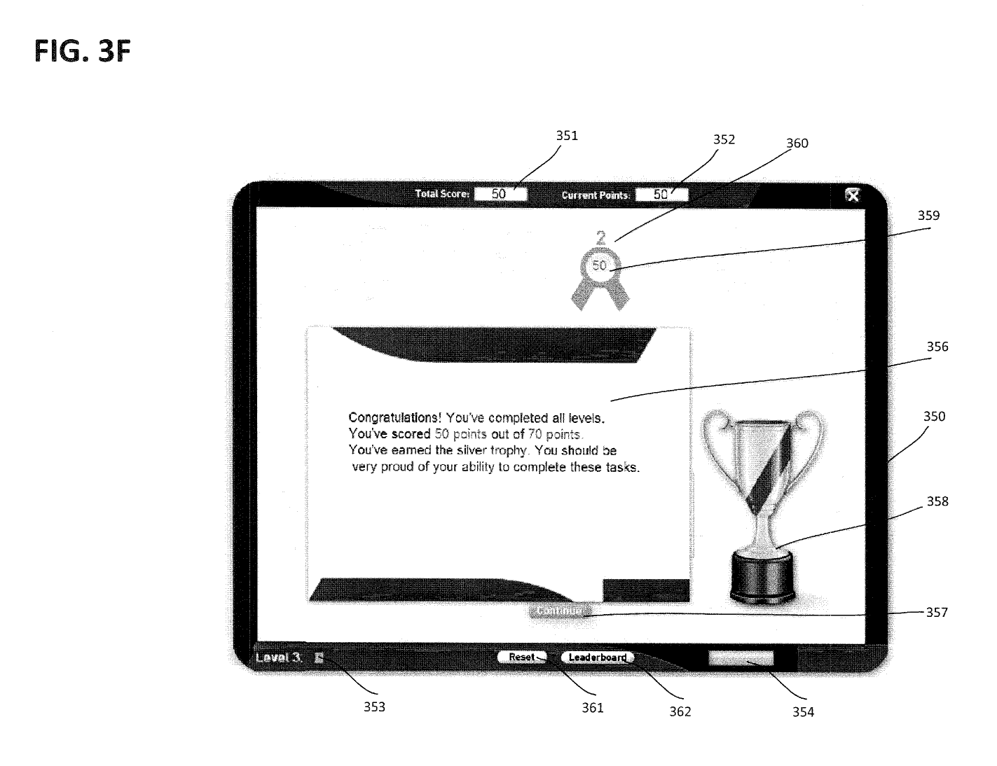

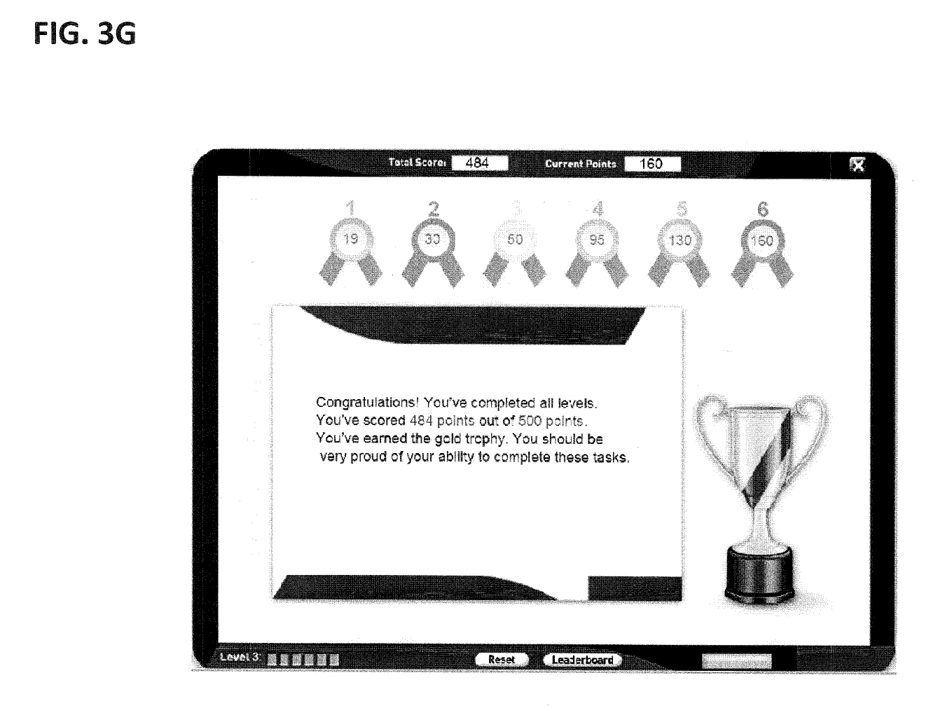

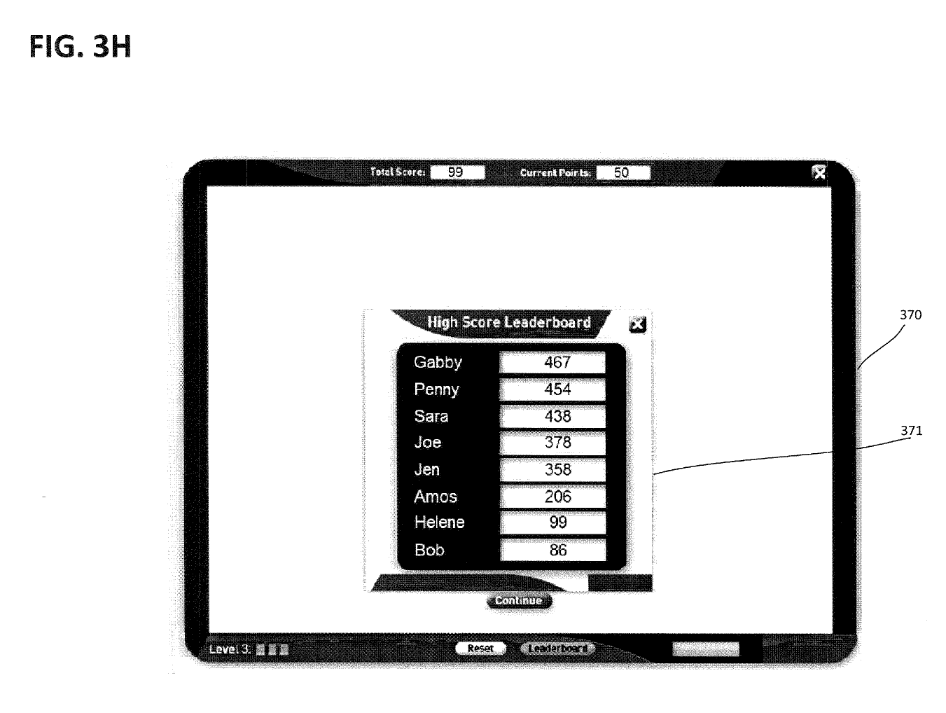

FIGS. 3A-3H illustrate an example of a series of interactive displays of a challenge task of Level 3 of the gamified training platform presented to the users according to an embodiment of the present disclosure. Following table shows the sequence of the correct actions that are requested to be performed by the user within Level 3, which will be described in detail referring to FIGS. 3A-3H as below. As each action must be performed correctly to progress to the next action, the simulation can be completely automated so as to train and allow the evaluation of the training without the need for instruction by a human trainer.

TABLE 1
List of requested correct actions for Level 3

| Step | Correct Action | Alternate Action | Keystroke Reference |
|---|---|---|---|
| 1. | Click Next. | | 307 |
| 2. | Click Next. | | 317 |
| 3. | Click C. | | 328 |
| 4. | Click row 2. | | 338 |
| 5. | Click Save Score. | | 348 |
| 6. | Click Continue. | | 357 |

As shown in FIG. 3A, an interactive page 300 is displayed on the screen. A total score field 301 and current point field 302 are displayed to indicate the user's current and total scores. A level indicator 303 indicates that the user is working on Level 3 of the training program. A progress gauge 304 is a graphic indicating the current progress of Level 3, shown as a bar graph. A virtual instructor 305, “Nina,” is shown in a business setting, shown as an office, and gives a brief instruction of the current level by presenting text information 308 in the dialogue box 306. For example, in FIG. 3A, the virtual instructor 305 tells the user “In this level, you'll answer two typical questions you might get on the job. If you answer correctly on the first try, you will earn 50 points. Second and third tries won't count. Click Next to begin.” The user is requested to perform an action by a clicking “Next” button 307, as described in Table 1, presented in the dialogue box 306.

Then the next interactive page 310 is displayed on the screen as shown in FIG. 3B, in which another virtual character 315 presents his problem 316 in the dialogue box 306 to the user. For example, the virtual character 315 says “Hey-I just found out I'm going to be terminated this Friday. When do I get my last check?” Now the user is requested to perform an action by clicking “Next” button 317 presented in the dialogue box 316.

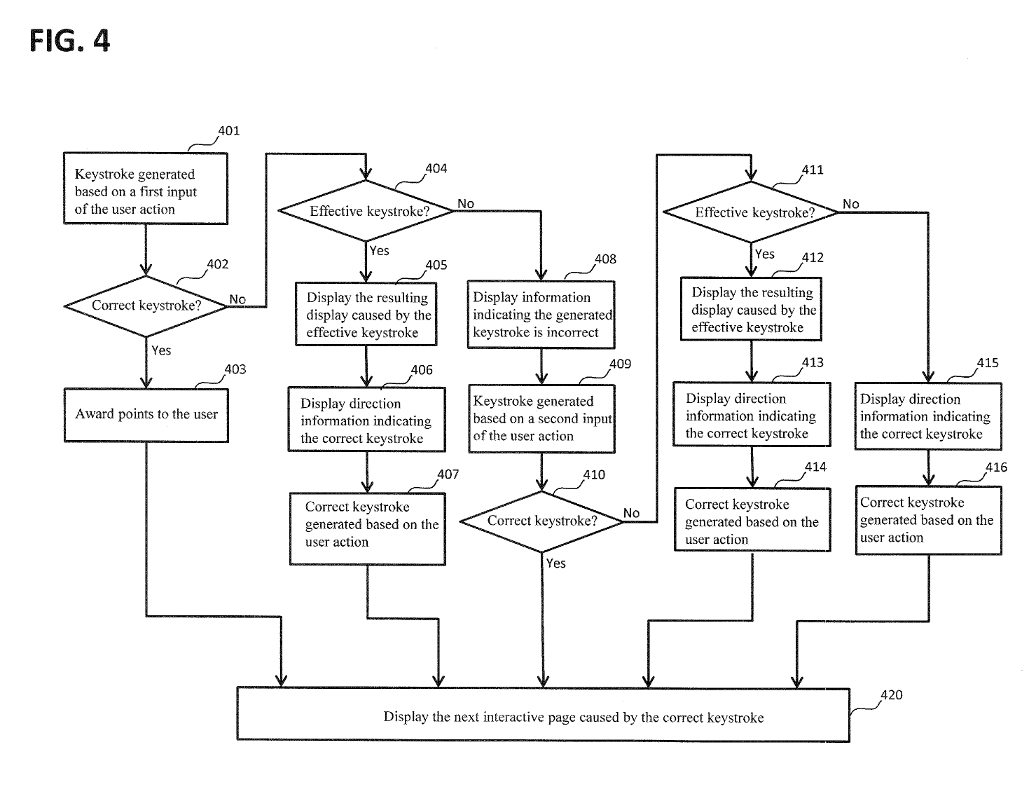

The next interactive page 320 is displayed on the screen as shown in FIG. 3C, in which the virtual instructor 305 present a first question 326 of Level 3 in the dialogue box 306 to the user. For example, the virtual instructor 305 says “Tom is a salaried employee who is terminated. You changed his status to Terminated but forget to cancel Automatic Pay. When will Tom get his last check if you don't post his earnings manually,” and then the virtual instructor 305 gives instruction as “Click the correct answer from the choices below” to the user in text box 327. In text box 329, four choices are displayed, and the user is requested to perform an action to answer this question. A process for scoring the user's action will be described below referring to FIG. 4.

FIG. 4 illustrates a process for collecting input data as well as scoring the user's action according to an embodiment of the present disclosure. As shown in FIG. 4, in step 401, the user performs an action, as a first try, to generate a first data input. The data input is described in terms of a keystroke, however the term “keystroke” is understood to include and be representative any data input by a user, for example, via mouse input, touchscreen, keyed input, or any data input method known in the art. In step 402, if it is determined that the generated first keystroke is correct input, “yes” line leads to step 403 in which the corresponding points may be awarded to the user. Then in step 420 the next interactive page caused by the correct keystroke may be displayed.

Referring back to step 402, if it is determined that the generated first keystroke is incorrect input, “no” line leads to step 404 which determines if the generated first keystroke is an effective keystroke. For example, if the user clicks a button which will lead to another resulting interactive page of the training application, the corresponding keystroke is determined as an effective keystroke, then “yes” line leads to step 405 in which the resulting page caused by the effective keystroke will be displayed on the screen. Then direction information indicating the correct keystroke is displayed in step 406. In step 407 the user performs the correct action to generate the correct keystroke according to the direction information. Although no points will be awarded to the user, in step 420 the next interactive page caused by the correct keystroke may be displayed.

Referring back to step 404, if it is determined that the generated first keystroke is not an effective keystroke, “no” line leads to step 408 in which information indicating that the generated first keystroke is incorrect may be displayed. Then in step 409, the user performs an action, as a second try, to generate a second keystroke. In step 410, if it is determined that the second generated keystroke is correct input, “yes” line leads to step 420 in which the next interactive page caused by the correct keystroke may be displayed, and the user is not awarded to the corresponding points.

Referring back to step 410, if it is determined that the generated second keystroke is incorrect input, “no” line leads to step 411, in which if it is determined that the generated second keystroke is an effective keystroke, “yes” line leads to step 412 in which the resulting page caused by the effective keystroke will be displayed on the screen. Then direction information indicating the correct keystroke is displayed in step 413. After the user performs the correct action to generate the correct keystroke according to the direction information in step 414, in step 420 the next interactive page caused by the correct keystroke may be displayed, and also, no points will be awarded to the user.

Referring back to step 411, if it is determined that the generated second keystroke is not an effective keystroke, “no” line leads to step 415 in which direction information indicating the correct keystroke is displayed. In step 416 the user performs the correct action to generate the correct keystroke according to the direction information, and then in step 420 the next interactive page caused by the correct keystroke may be displayed, and also, no points will be awarded to the user.

In this embodiment, the above described scoring process is performed for every keystroke generated by the user's action for answering training questions. However, the keystrokes generated by the user inputs unrelated to training on a business application or answering a substantive question are not scored, for example on the clicking of a “Next” button, “Continue” button, or any other areas in the interactive display page that may not be counted for the points.

Referring back to FIG. 3C, according to the scoring process described above, after the correct keystroke is generated by the user's action of moving a pointer to and clicking row on C, or by entering “C” on a keyboard, which is identified as keystroke 328 in Table 1, whereupon a text box 339 indicates the user's answer is correct, and then the next interactive page 330 may be displayed on the screen as shown in FIG. 3D. Designers can determine point levels based on the difficulty of each interaction.

As shown in FIG. 3D, in the interactive page 330, current point field 332 indicated that the user was awarded 25 points for correctly answering the previous question in the interactive page 320 at the first try. The virtual instructor 305 presents a second question 336 for Level 3 in the dialogue box 306 to the user. For example, the virtual instructor 305 says “Someone's Automatic Pay was canceled in this batch. Which row has the entries that will cancel Automatic Pay? Click that row.” The user is presented with an interactive screen shot that presents a simulated business application 331 for a real work scenario, here shown a payroll management software, thus allowing the user to obtain more effective training that carries over directly to use of the business application in routine use. Now the user is requested to perform an action to generate the correct keystroke. The process for scoring the user's action is same as the above described process referring to FIG. 4. After the correct keystroke is generated by the user's action of clicking row 2, which is keystroke 338 as described in Table 1, text box 339 indicates the user's answer is correct, and then the next interactive page 340 may be displayed on the screen as shown in FIG. 3E.

As shown in FIG. 3E, in the interactive page 340, current point field 342 indicated that now the user's current points are 50, i.e., the user was awarded another 25 points for correctly answering the question in the interactive page 330 at the first try. The virtual instructor 305 tells the user “You've completed this level. Click Save Score to see your badge.” 346 in dialogue box 306. After the correct keystroke is generated by the user's action of clicking “Save Score” button, which is keystroke 348 as described in Table 1, the next interactive page 350 may be displayed on the screen as shown in FIG. 3F.

As shown in FIG. 3F, in the interactive page 350, current point field 352 indicates the current points earned by the user in Level 3 is 50 points. The current score is added to the total score after the user completes each level, so that the total sore field 351 indicates the user's total score is 50. Level indicator 353 indicates that the user is working on Level 3 of the training program. The Progress gauge 354 indicates the current process of Level 3, i.e., the user has completed Level 3. After completing all levels, users may receive a gold, silver, or bronze trophy based on their total score. A simple plaque is awarded if the user's cumulative score is below the score required for a bronze trophy. For example, as shown in FIG. 3F, the text box 356 indicates the user has completed all levels and earned a silver trophy 358, which is displayed on the screen. Also, a badge 359 is displayed to indicate the user's total score, and ranking number 360, which indicates the user's score is ranked as the second highest, is also displayed on the screen.

Alternatively, when the interactive page showing the badges is displayed, all the badges that have been earned in the previously levels may be displayed together with the badge earned for the current level, as shown in FIG. 3G.

To continue the training program and move to the next level, the user is requested to perform an action by clicking “Continue” button 357, as described in Table 1. Alternatively, at the end of each level, the user may click the Reset button 361 to retake this level, which will reset their current points to zero and subtract the current points from the total score, but will not erase any points earned in prior levels.

If the user clicks “Leaderboard” button 362 as shown in FIG. 3F, a leaderboard 371 displaying a rankings list of fictitious names and scores of users may be displayed on the interactive page 370, as shown in FIG. 3H. As noted above, a user may be allowed to enter a pseudonym as a user name, which will allow a user to identify themselves on a leaderboard display without knowing or revealing their display to other trainees participating the PES session. In such an embodiment, the PES can create a competitive environment without negatively affecting morale among peer employees or trainees. However administrative users such as the PES provider or employer management can know the user identities for purposes of evaluation.

As will be appreciated, FIGS. 3A-3H show exemplary non-limiting examples of a series of interactive pages of challenge tasks within a particular level of the gamified training application, however these interactive pages and the associated actions can be implemented for any simulated task other than those mentioned.

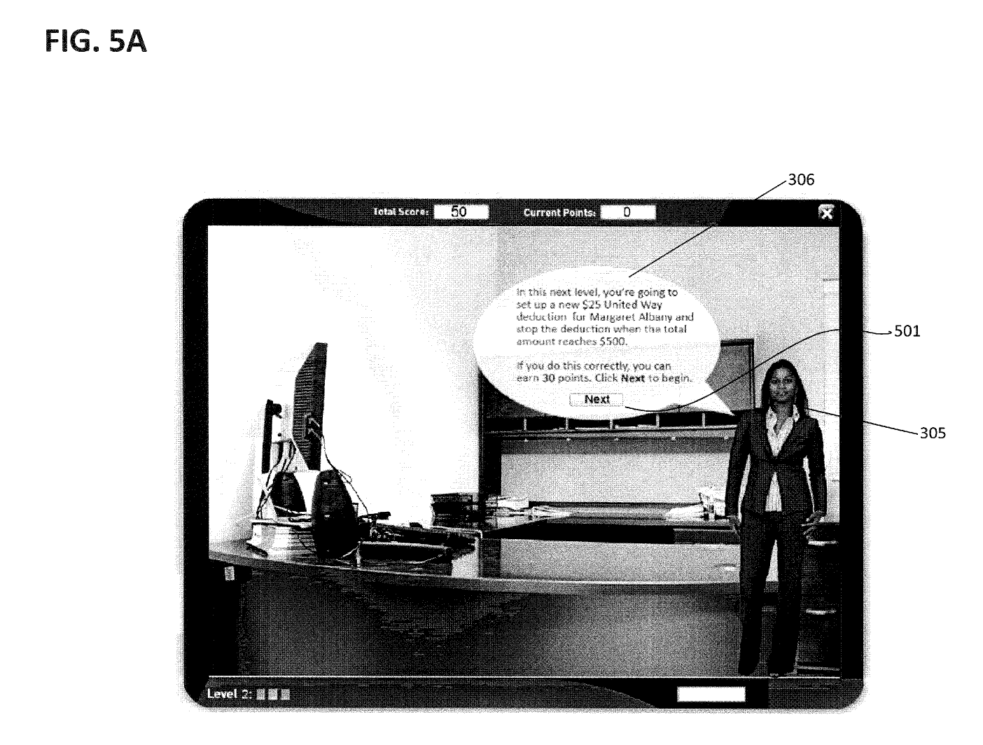

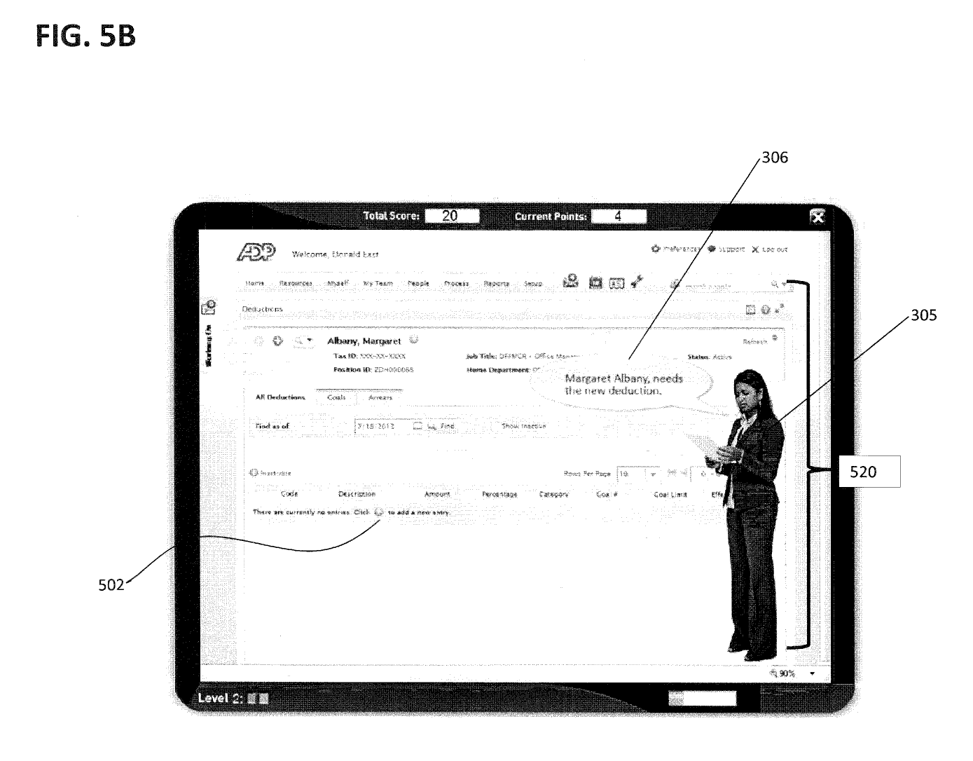

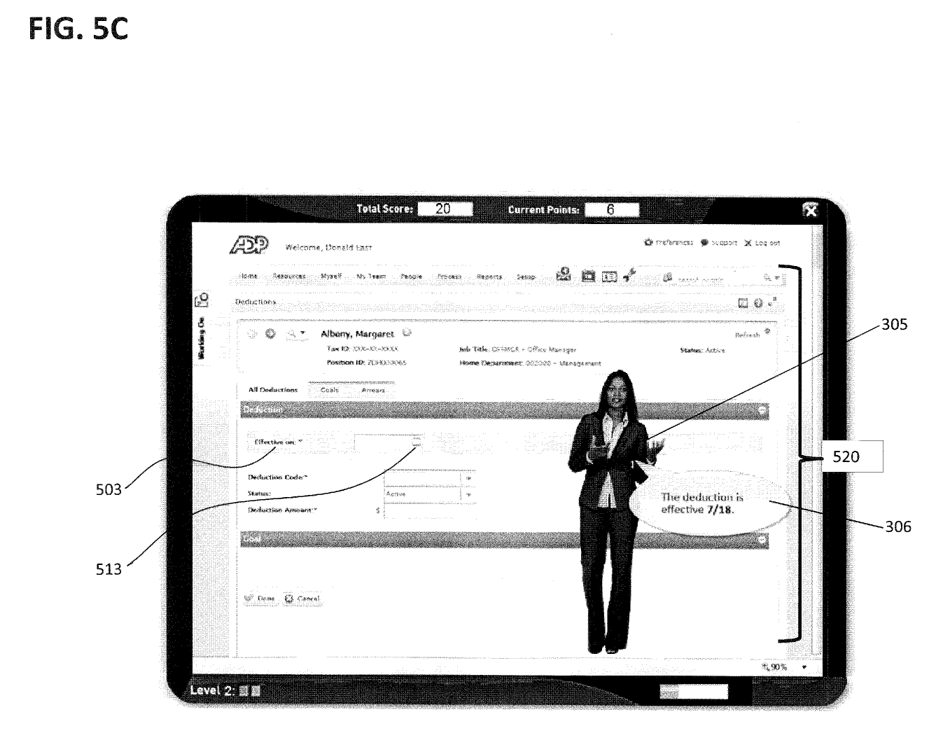

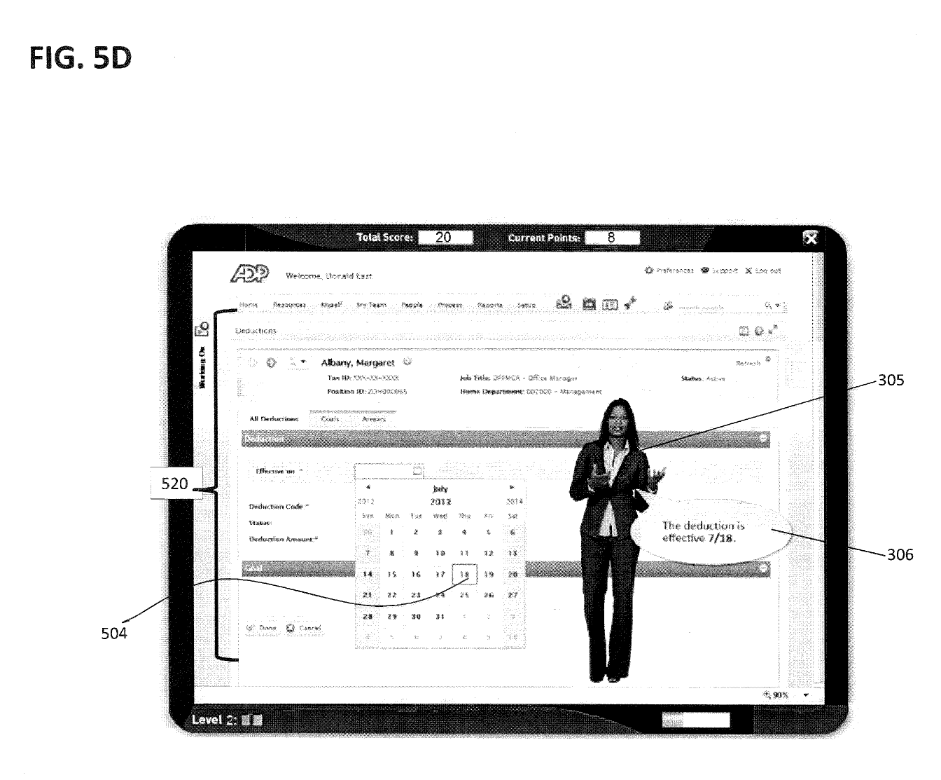

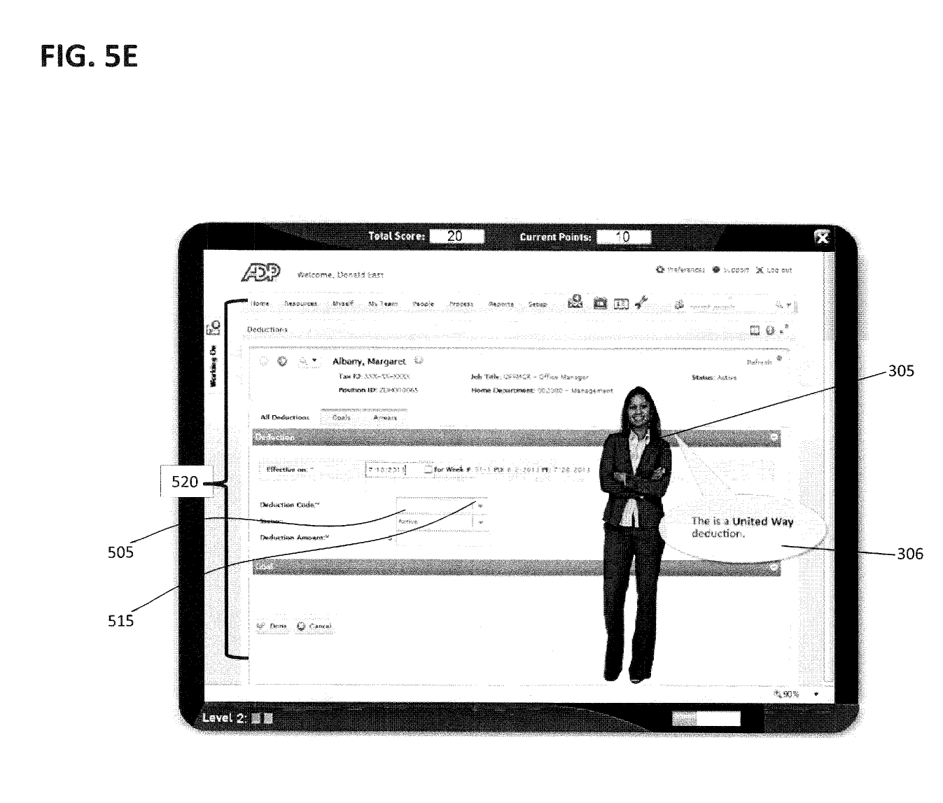

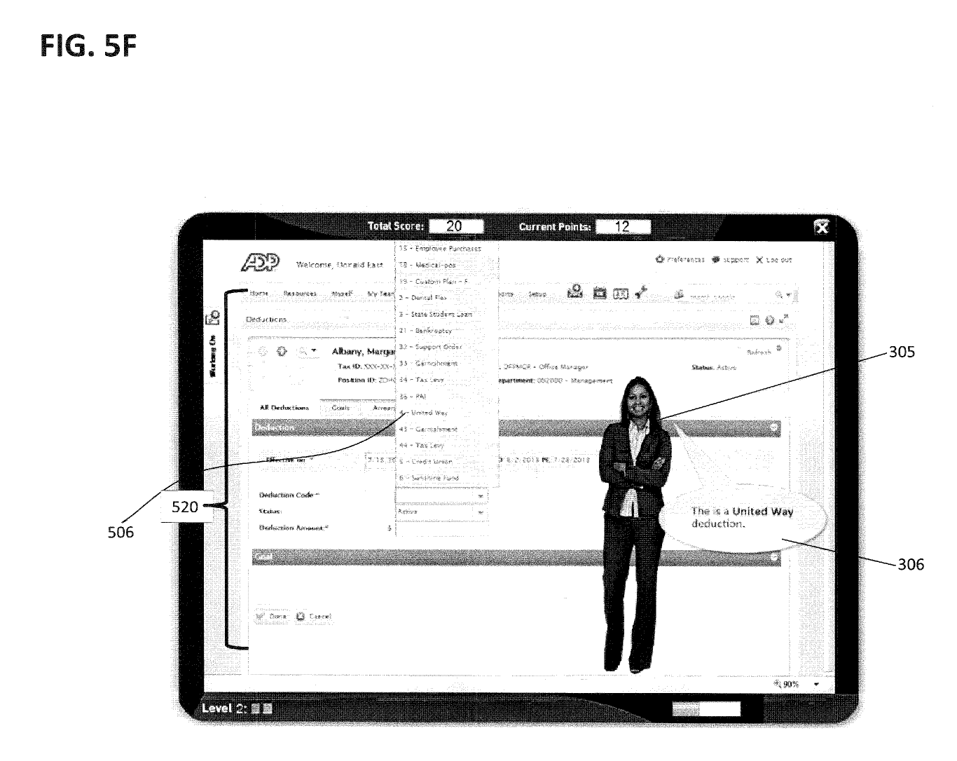

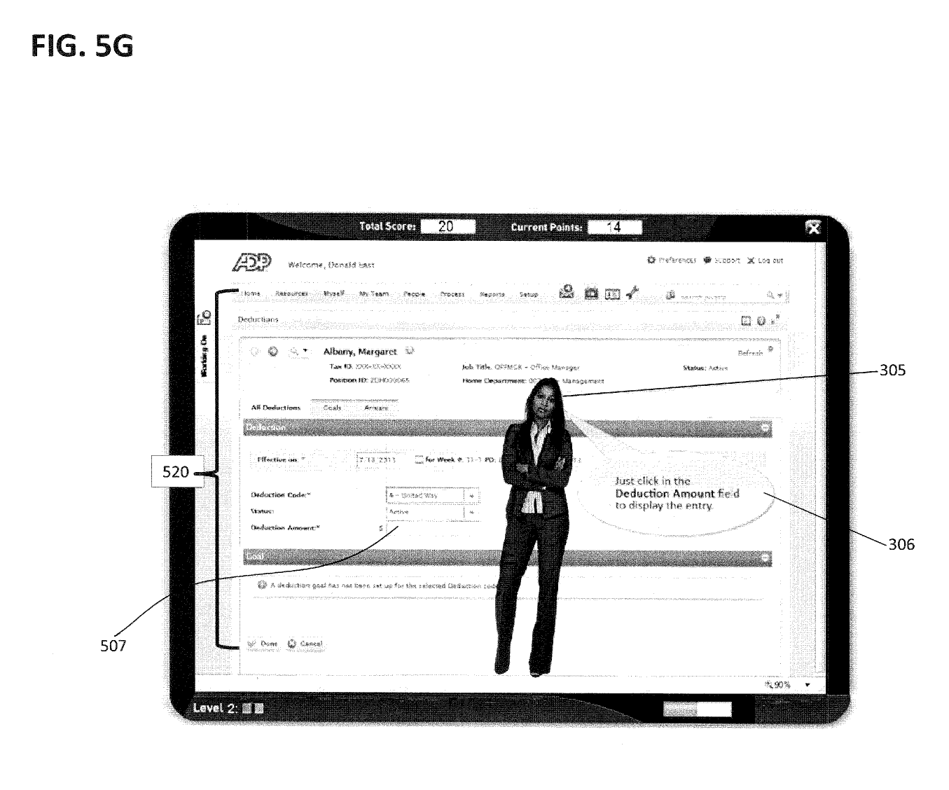

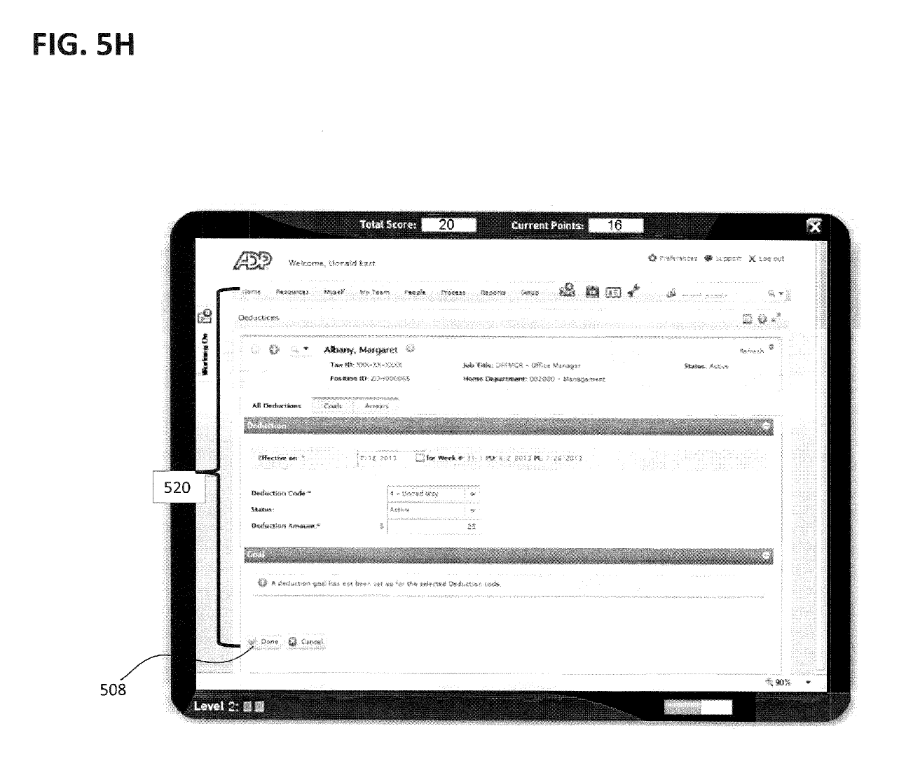

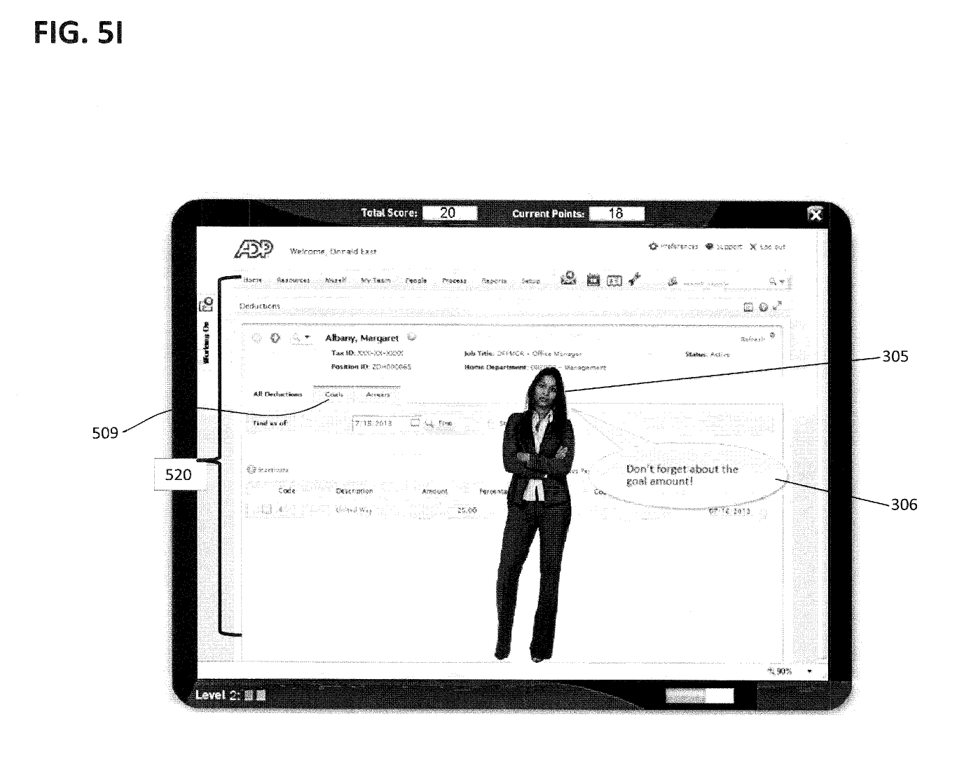

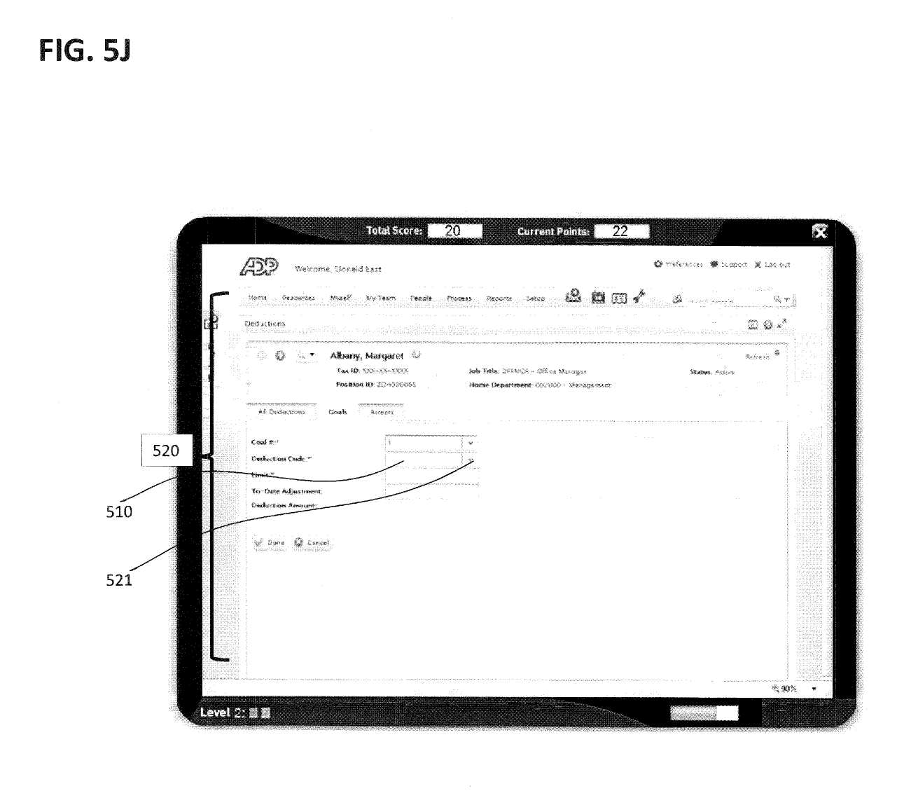

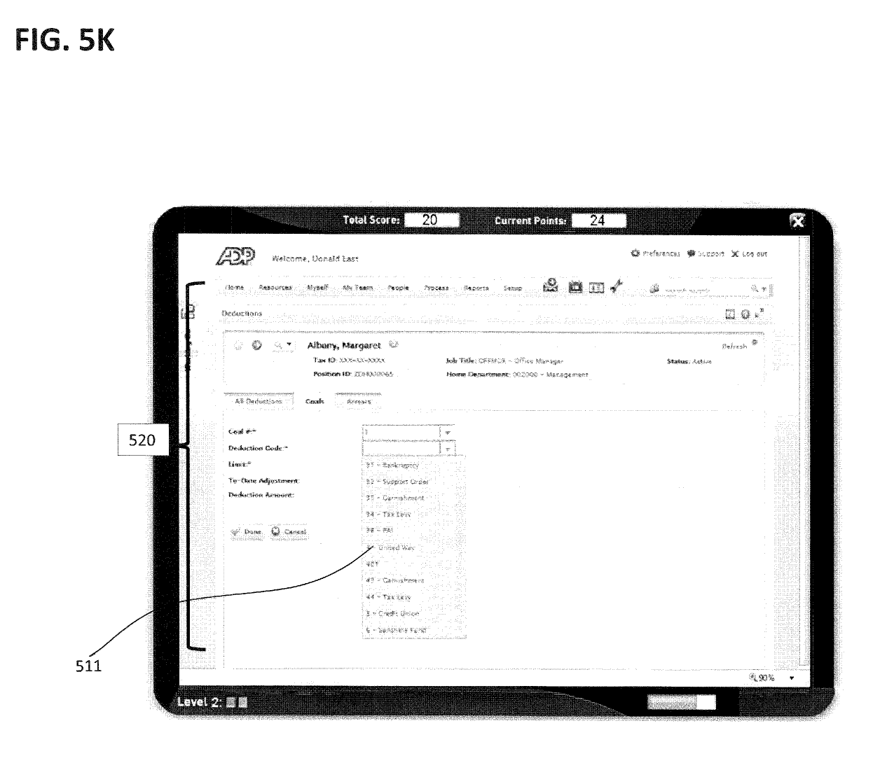

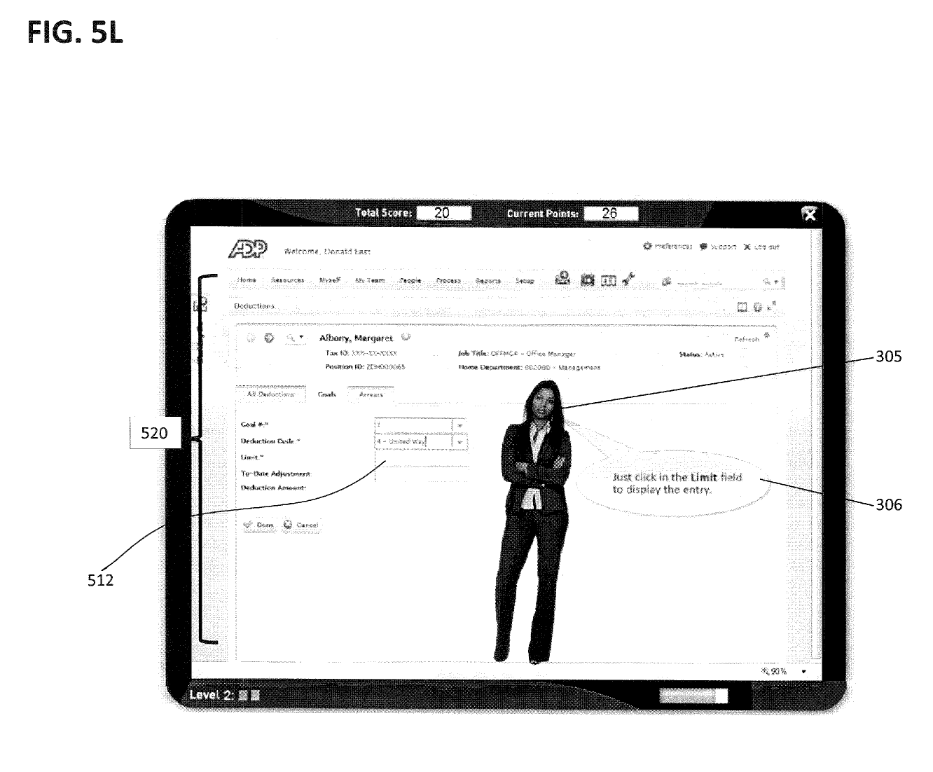

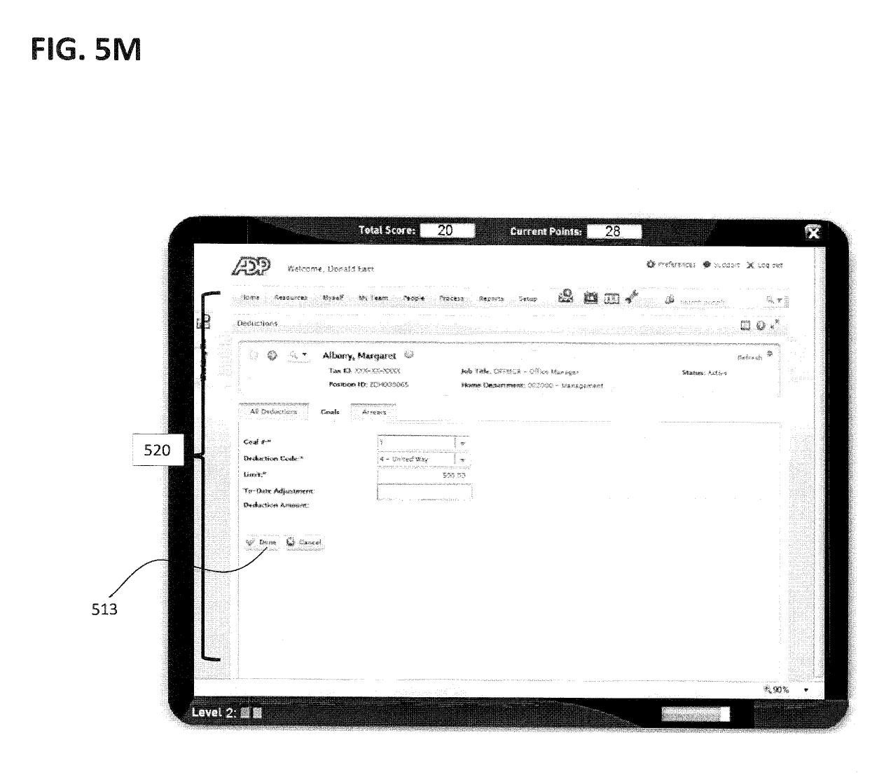

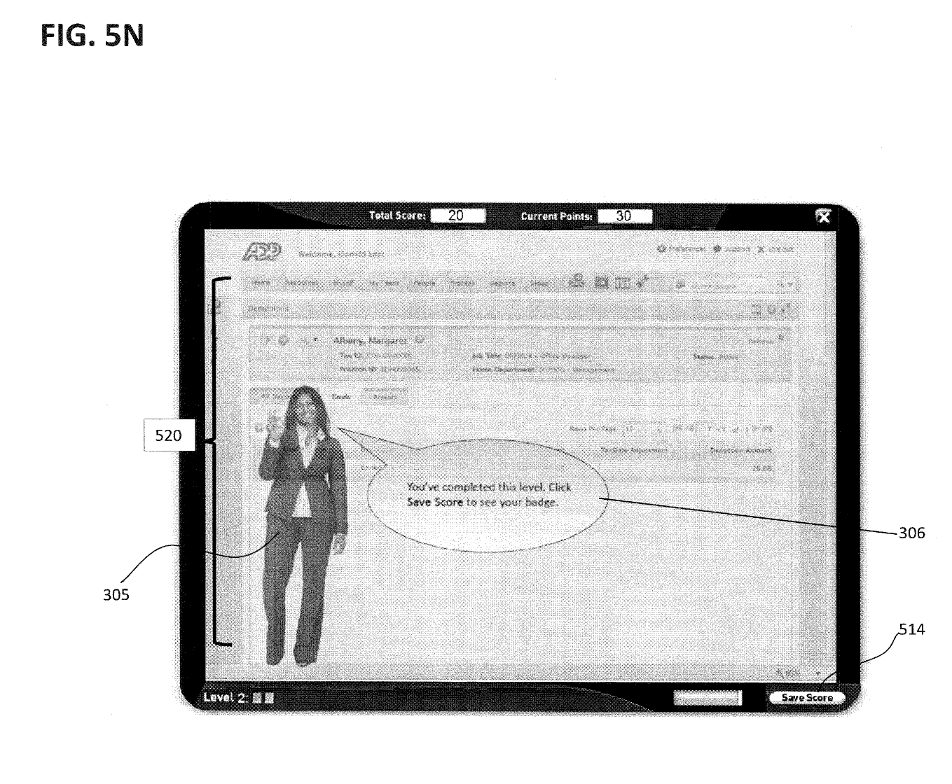

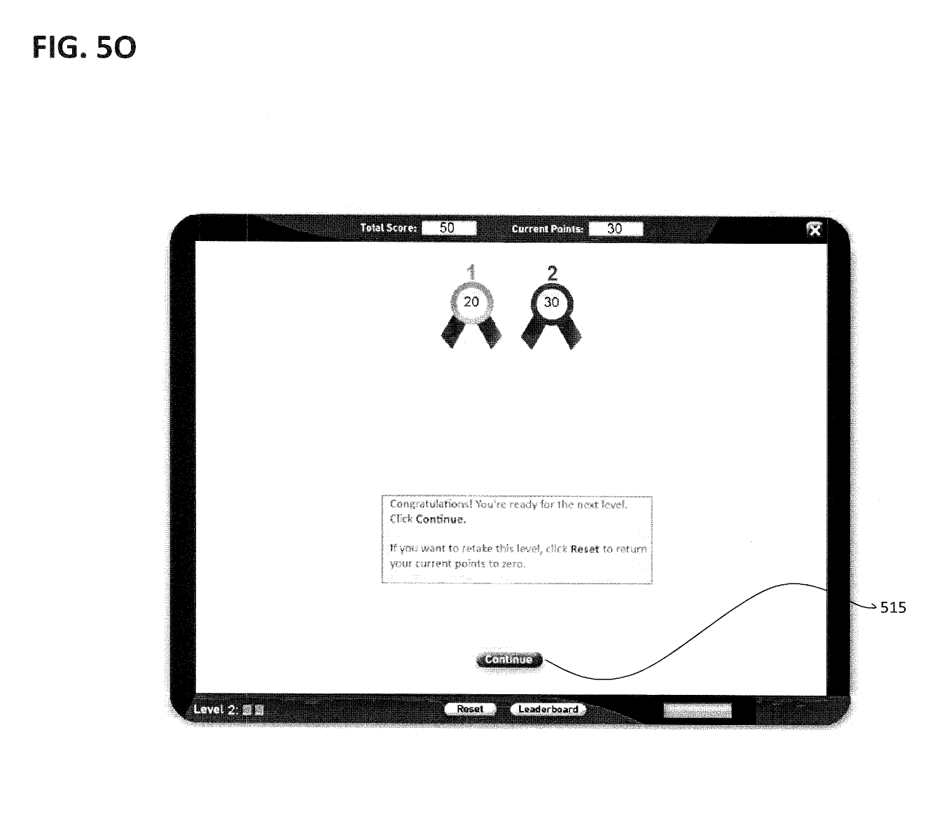

For example, following Table 2 and the associated FIGS. 5A-5O shows the sequence of the requested correct actions to be performed by the user within Level 2.

TABLE 2
List of requested correct actions for Level 2

| | | Alternate | Keystroke |
|---|---|---|---|
| Step | Correct Action | Action | Reference |
| 1. | Click Next. | | 501 |
| 2. | Click Add New.. | | 502 |
| 3. | Click in Effective On field or Calendar | | 503 or 513 |
| | icon. | | |
| 4. | Click 7/18. | | 504 |
| 5. | Click in the Deduction Code field or on | | 505 or 515 |
| | the down arrow. | | |
| 6. | Select 4 - United Way. | | 506 |
| 7. | Click in the Deduction Amount field. | | 507 |
| 8. | Click Done. | | 508 |
| 9. | Click the Goals tab. | | 509 |
| 10. | Click in the Deduction Code field or on | | 510 or 521 |
| | the down arrow. | | |
| 11. | Select 4 - United Way. | | 511 |
| 12. | Click in the Limit field. | | 512 |
| 13. | Click Done. | | 513 |
| 14. | Click Save Score. | | 514 |
| 15. | Click Continue. | | 515 |

FIGS. 5A-5O show a series of interactive pages of challenge tasks related to entering a deduction and goal within Level 2. Again, the user is presented with an interactive screen shot that presents a secures of actions that simulate a common work task for a simulated business application 520, here shown a deductions function from payroll management software, thus allowing the user to obtain more effective training that carries over directly to use of the business application in routine use. Also, the virtual instructor 305, “Nina,” is presented on the GUI to give instructions on performing the actions for current level by presenting text information in the dialogue box 306. As shown in Table 2, there may be more than one correct action for some challenge tasks, allowing for alternative correct answers to move to the next correct action in the sequence. For example, in FIG. 5C, both “Effective on” filed 503 and “Calendar” icon 513 are the correct actions as described in step 3 of the Table 2. Similarly, in FIG. 5E, both “Deduction Code” filed 505 and “down arrow” 515 are the correct actions as described in step 5, and in FIG. 5J, both “Deduction Code” filed 510 and “down arrow” 521 are the correct actions as described in step 10 of the Table 2.

Similarly to the interactive pages and acts shown in Table 1 and FIGS. 3A-3H, following Tables 3-6 shows the sequence of the requested correct actions to be performed by the user to complete Levels 1 and 4-6, respectively.

TABLE 3
List of requested correct actions for tasks related
to setting up a direct deposit within Level 1

| Step | Correct Action | Alternate Action |
|---|---|---|
| 1. | Type your name and press or click Enter. | |
| 2. | Click Next. | |
| 3. | Click Payroll. | |
| 4. | Click Employee. | Click Payroll then |
| | | click Employee. |
| 5. | Click the Employees tab. | Click Employee List. |
| 6. | Select Frank Cavallo. | Select Frank Cavallo. |
| 7. | Click the Menu tab. | |
| 8. | Click Deductions/Deposits. | |
| 9. | Click the Deposits tab. | Click Add New then |
| | | click the Deposits tab. |
| 10. | Click Add New. | |
| 11. | Click the Effective On field or the | |
| | Calendar icon. | |
| 12. | Select 4/29. | |
| 13. | Click the Deduction Code field. | |
| 14. | Select W Checking Account 1d. | |
| 15. | Click the Full Deposit checkbox. | |
| 16. | Click the Transit ABA Number field. | |
| 17. | Click the Bank Deposit Account | |
| | Number field. | |
| 18. | Click Done. | |
| 19. | Click Save Score. | |
| 20. | Click Continue. | |

As shown in Table 3, besides the requested correct action, alternate action performed by the user may also lead to the following interactive page which may be presented when the correct keystroke is generated. For example, in step 5 of Table 3, correct action “click the Employees tab” and alternate action “click Employees list” may lead to the same interactive page (the same interactive page is not shown).

TABLE 4
List of requested correct actions for tasks related to
making a temporary change to a deduction within Level 4

| Step | Correct Action | Alternate Action |
|---|---|---|
| 1. | Click Next. | |
| 2. | Click Payroll. | |
| 3. | Click Payroll. | |
| 4. | On the left, click Paydata. | Click the Pay |
| | | Employees Icon. |
| 5. | Click Add New. | |
| 6. | Click in the Batch ID field. | |
| 7. | Click in the Description field. | |
| 8. | Click Next. | |
| 9. | Click Samuel Barbato's name. | |
| 10. | Click Create Batch. | |
| 11. | Click the Temporary Rate column. | |
| 12. | Click Insert Column. | |
| 13. | Click the down arrow in the Paydata Field. | |
| 14. | Select Replace Deduction. | |
| 15. | Click the down arrow in the Code/Type field. | |
| 16. | Click 3 - Student Loan. | |
| 17. | Click Done. | |
| 18. | Click in the Replace Deduction - Student Loan | |
| | field. | |
| 19. | Click Done. | Click Save then |
| | | click Done |
| 20. | Click in the Replace Deduction - Student Loan | |
| | field on the Your Total row. | |
| 21. | Click Done. | |
| 22. | Click Save Score. | |
| 23. | Click Continue. | |

TABLE 5
List of requested correct actions for tasks related
to entering a second check for a bonus within Level 5

| Step | Correct Action | Alternate Action |
|---|---|---|
| 1. | Click Next. | |
| 2. | Click in the Temporary Rate column. | |
| 3. | Select Insert Column. | |
| 4. | In the Paydata Field, click the down arrow. | |
| 5. | Select Other Earnings. | |
| 6. | In the Code/Type field, click the down | |
| | arrow. | |
| 7. | Select B - Bonus. | |
| 8. | Click Done. | |
| 9. | Click in the Other Earnings - Bonus field. | |
| 10. | Click in the Tax Frequency field. | |
| 11. | Select B - Bonus. | |
| 12. | Click in the Pay # field. | |
| 13. | Select 2. | |
| 14. | Click Done. | Click Save and then |
| | | click Done. |
| 15. | Click in the Other Earnings - Bonus field. | |
| 16. | Click Done. | |
| 17. | Click Save Score. | |
| 18. | Click Continue. | |

TABLE 6
List of requested correct actions for tasks
related to verifying paydata entries within Level 6

| Step | Correct Action | Alternate Action |
|---|---|---|
| 1. | Click Next. | |
| 2. | Click Reports. | |
| 3. | Click Payroll Reports. | |
| 4. | Under Audit Reports, click Paydata. | |
| 5. | On the far right, click Automatic Pay | |
| | Cancellation. | |
| 6. | Click Run Report. | |
| 7. | Click the X as indicated. | |
| 8. | Under Report Name, click Automatic Pay | |
| | Cancellation Report. | |
| 9. | Click Save Score. | |
| 10. | Click the X in the browser to close the game. | |

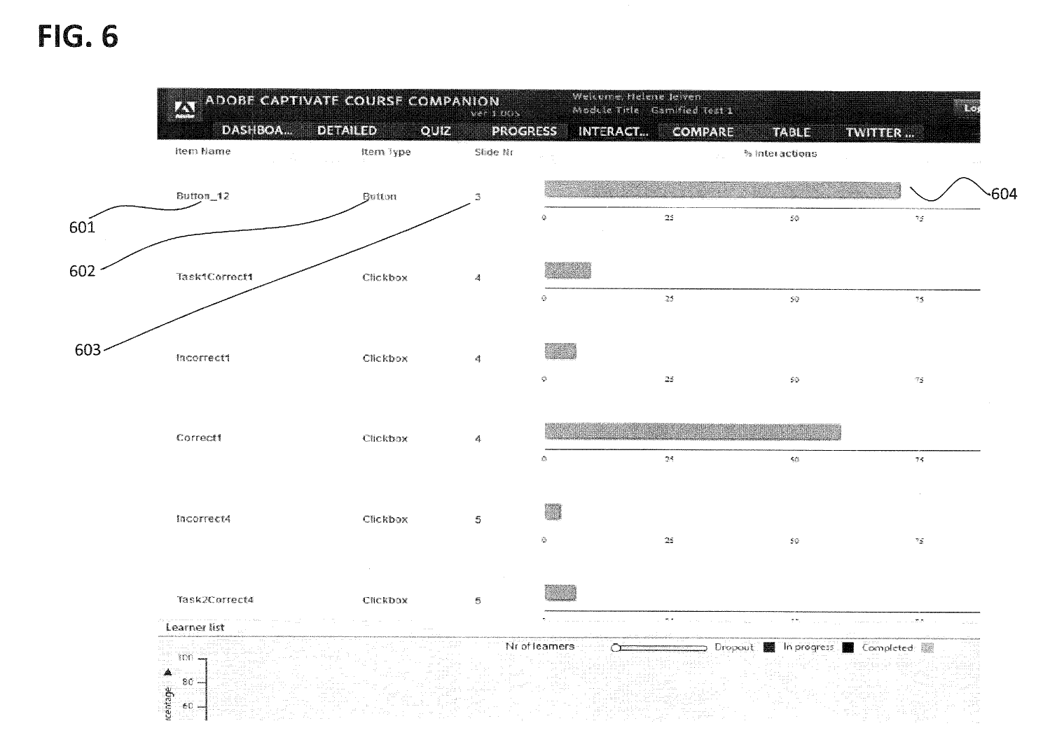

FIG. 6 illustrates an example of an analysis result of the user's action within the gamified training platform according to an embodiment of the present disclosure. According to an embodiment, input data and user's action are collected and provided as feedback to the designer of the simulated product using programs known in the art. In the exemplary embodiments herein, Adobe Captivate is employed, however as will be appreciated, any tool or software known in the art that can, inter alia, capture the product screen and simulate the interactive portion of the product may be used to create the gamified training application.

In FIG. 6, an analysis result based on the collected input data and user actions is shown. Column “Item Name” includes a plurality of clicked object names 601, for example, “Button_12”. Column “Item Type” includes a plurality of object type 602, for example, “Button” indicating object “Button_12” is a button in the interactive page. Column “Slide Nr” includes a plurality of numbers 603 indicating the number of the slide on which the clicked object is located. Column “% Interactions” includes a plurality of indicator 604 indicating the percentage of users who has performed actions on the corresponding object as against all users of the gamified training application. For example, the first row of the chart in FIG. 6 indicates that object “Button_12” is a button on the third slide, and about 70% users have clicked Button_12 when using the gamified training application.

In an embodiment, the user input data gathered by the system, for example as recorded and shown can be stored and processed by data analysis module 102 includes training analysis module 121, database 122, product evaluation module 123, memory 124 and processor 125 as shown in FIG. 1. The user input data can be recorded and stored in a training data database 122. As will be appreciated, the storage of the data over time will allow further analysis of what is known as “Kirkpatrick Level 2 evaluation” of the “Kirkpatrick Levels of Evaluation.”Kirkpatrick Level 1 Evaluation,” named “Reaction,” is limited to gaining feedback from those individuals that have received training. For example, what people thought of the trainer, or how well the training material was presented. “Kirkpatrick Level 2 Evaluation,” called “Learning” is for ensuring that some learning has actually taken place as a result of the training—determining if a trainee now equipped with some new knowledge or skill that they did not have before the training was delivered. One advantage of the systems and methods described herein is the accumulation of trainee data that allows ID and SD to accurately and objectively determine from the automated implementation of the system whether actual learning has occurred from training, as for example by the percentages and trends for correct answers and the speed at which they are learned or given. Further, analysis of the data over time can be used to determine which training simulations are effective, as for example where large percentages of employees learn business applications quickly as determined by correct data inputs for a simulation, and which do not, as for example training materials that consistently produce incorrect inputs or low scores, or show long lag times before correct answers are input.

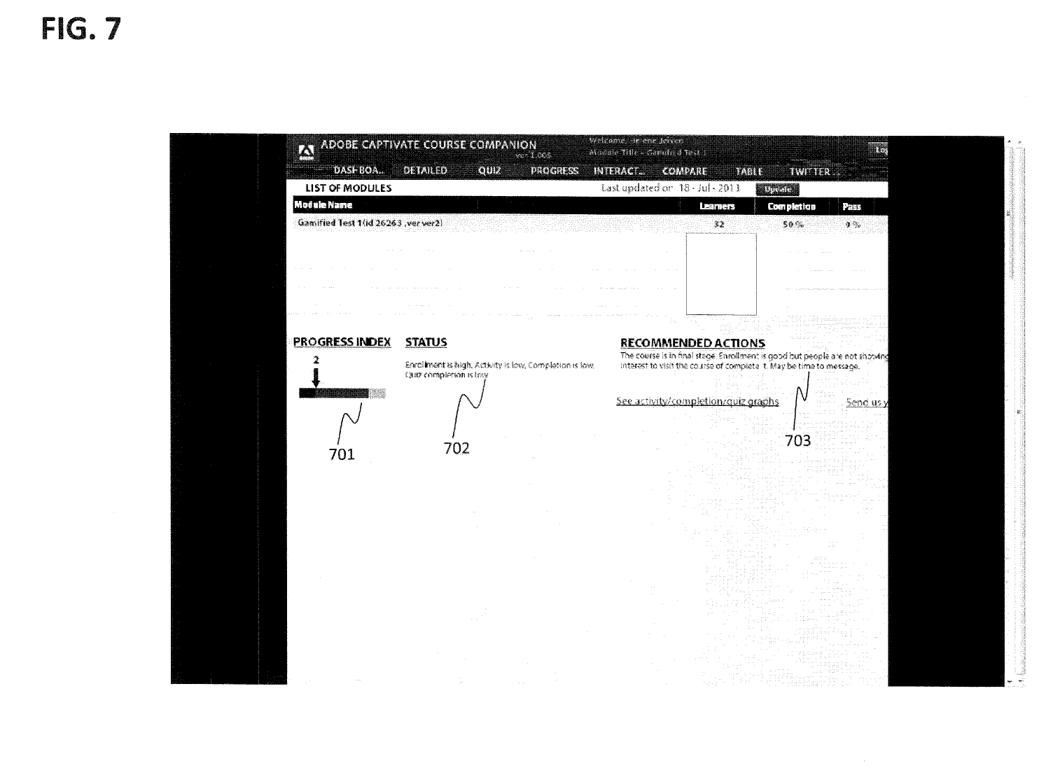

FIG. 7 illustrates another example of an evaluation result of the gamified training platform according to an embodiment of the present disclosure, which can be available to administrative users such as employer management or the PES provider. In FIG. 7, progress index 701 indicates ratio of users at different status such as dropout, in progress and completed. Status 702 indicates status of all the users, for example, as shown in FIG. 7, status 702 indicates “Enrollment is high, activity is low, completion is low, and quiz completion is low.” Recommended Actions 703 indicates some recommendations based on the progress index 701 and status 702. For example, in FIG. 7, recommended Actions 703 shows “The course is in final stage, enrollment is good but people are not showing interest to visit the course of complete. May be time to message.”

Evaluation of a trainee's scores by either the trainee or a trainer may indicate that the particular trainee has mastered one or more of the work-related scenario tasks, or not. This information is important as that trainee may want or need to repeat key training concepts and not others. Analyses of the trainee's scores may identify specific weak and strong areas.

Evaluation of multiple trainee scores by an ID may provide insight into the effectiveness of a particular training subject area. For example, if multiple trainees score poorly on a particular Level or a specific task within such a Level, training lessons may be modified to alleviate any training lesson deficiency.

Evaluation of multiple trainee scores by an ID or SD system designer may provide insight into imperfections in the system, and how the system may be improved. The gamified training challenges can also be employed to evaluate whether a trainee is in need of addition specific training, whether a training module is effective, or whether, and how, HCM productivity enhancing systems may be improved.

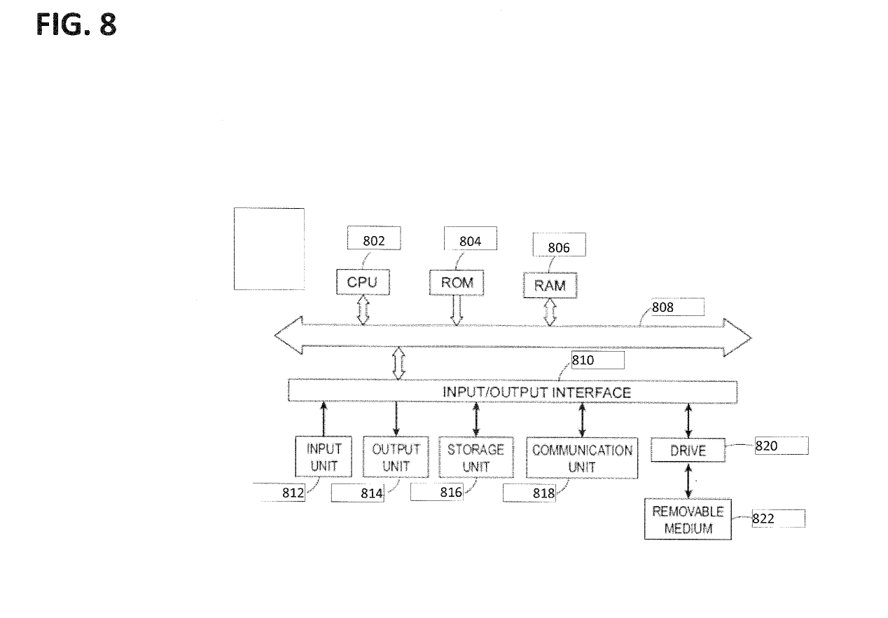

FIG. 8 illustrates an exemplary structure of a server, system, or a terminal according to an embodiment.

The exemplary server, system, or terminal 800 includes a CPU 802, a ROM 804, a RAM 806, a bus 808, an input/output interface 810, an input unit 812, an output unit 814, a storage unit 816, a communication unit 818, and a drive 820. The CPU 802, the ROM 804, and the RAM 806 are interconnected to one another via the bus 808, and the input/output interface 810 is also connected to the bus 808. In addition to the bus 808, the input unit 812, the output unit 814, the storage unit 816, the communication unit 818, and the drive 820 are connected to the input/output interface 810.

The CPU 802, such as an Intel Core or Xeon series microprocessor or a Freescale® PowerPC® microprocessor, executes various kinds of processing in accordance with a program stored in the ROM 804 or in accordance with a program loaded into the RAM 806 from the storage unit 816 via the input/output interface 810 and the bus 808. The ROM 804 has stored therein a program to be executed by the CPU 802. The RAM 806 stores as appropriate a program to be executed by the CPU 802, and data necessary for the CPU 802 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 812 includes a keyboard, a mouse, a microphone, a touch screen, and the like. When the input unit 812 is operated by the user, the input unit 812 supplies an input signal based on the operation to the CPU 802 via the input/output interface 810 and the bus 808. the output unit 814 includes a display, such as an LCD, or a touch screen or a speaker, and the like. The storage unit 816 includes a hard disk, a flash memory, and the like, and stores a program executed by the CPU 802, data transmitted to the terminal 800 via a network, and the like.

A removable medium 822 formed of a magnetic disk, an optical disc, a magneto-optical disc, flash or EEPROM, SDSC (standard-capacity) card (SD card), or a semiconductor memory is loaded as appropriate into the drive 820. The drive 820 reads data recorded on the removable medium 822 or records predetermined data on the removable medium 822.

One skilled in the art will recognize that, although the data storage unit 816, ROM 804, RAM 806 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 802, Input unit 812, communications unit 818, etc.

An operating system such as Microsoft Windows® (XP, 7 or 8), Linux® Mac OS® or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java? C, C++, C#, Visual Basic, VB.NET, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, tablet, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server or transmitted between a plurality of processing devices.

As used in this application, the terms “component” or “system” or “module” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components or modules may reside within a process and/or thread of execution and a component may be localized on one computer and/or distributed between two or more computers.

Systems and methods described herein may by implemented by software, firmware, hardware, or any combinations of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

1. A system for providing a productivity enhancing interactive training simulation, the system comprising:
a computing device including a processor and program memory storing instructions that, when executed, cause the computing device to at least:
provide a training platform to allow one or more users to access a gamified interactive training simulation;
establish a user profile for a user;
provide the user with the gamified interactive training simulation for a Graphic User Interface (“GUI”), the training simulation including at least one challenge task, each challenge task including a plurality of actions requiring correct data input for each action for the challenge task to be completed successfully, wherein challenge task includes actions for training a user to use a business application;
record entry input data entered by the users for the actions;
store the entry data in a training data database;
score the users based on correct entries of the users.

2. The system according to claim 1 wherein the training simulation includes one or more virtual characters in a virtual business setting to guide the user in the interactive training simulation.

3. The system according to claim 1, wherein the system is configured to:
detect a first incorrect entry for an action and display first instructive information indicating the entry is incorrect, and
detect a second incorrect entry for the same action and display second instructive information that directs the users to a correct entry.

4. The system according to claim 2, wherein the system is further configured to at least:
display, when the second incorrect entry is located at an area on the GUI display that leads to a particular simulation result, the particular simulation result prior to displaying the second instructive information which directs the users to the correct entry.

5. The system according to claim 1, wherein the system is further configured to at least: only score a first correct entry for each action.

6. The system according to claim 1, wherein the system is further configured to at least:
display a badge icon for indicating the score awarded to each of the users for each of the challenge tasks completed by the users.

7. The system according to claim 1,wherein the system is further configured to at least:
display a trophy when the users complete the challenge tasks for each of one or more training levels.

8. The system according to claim 1, wherein the system comprises:
a web based interface accessed by the users through a network to access the gamified interactive training simulation.

9. The system according to claim 1, wherein the system is further configured to at least:
calculate and display a total score of each of the users by adding up the awarded score for each of the challenge tasks.

10. The system according to claim 9, wherein the system is further configured to at least: award and display a plaque to a user with a total score higher than a predetermined requirement.

11. The system according to claim 2, wherein information provided by the one or more virtual characters is displayed in bubble dialogue boxes.

12. The system according to claim 1, wherein the interactive interface comprising gaming elements further comprises: a progress bar, a reset button to retake the challenge tasks, a level indicator, and a progress gauge.

13. The system according to claim 1, wherein the system is further configured to at least: when the users click a reset button, reset a current score awarded for a current training level to zero and subtracted the zeroed score from the total score.

14. The system according to claim 1, wherein the input entry data is recorded and stored in one or more databases.

15. The system according to claim 1, wherein the system is further configured to provide gamified sound effects for user input entries.

16. The system according to claim 1, wherein the simulated product is configured for productivity enhancing systems (PES), comprising Human Capital Management (HCM) business applications for payroll services, talent management, human resources management, benefits administration, and time and attendance management.

17. The system according to claim 1, wherein the system is further configured to at least:
provide one or more training levels associated with at least one challenge task, and
assign a level to the user based on the score of each challenge task.

18. The system according to claim 1, wherein the system is further configured to at least:
generate a leaderboard based on the scores of the users, wherein the leaderboard is accessible for display to the users.

19. An information processing method for adding gamification elements to simulated product for training and evaluating users comprising:
providing a training platform to allow one or more users access gamified interactive training simulation;
establishing a user profile for a user;
providing the user with the gamified interactive training simulation for a Graphic User Interface (“GUI”), the training simulation including at least one challenge task, each challenge task including a plurality of actions requiring correct data input for each action for the challenge task to be completed successfully, wherein challenge task includes actions for training a user to use a business application;
recording entry input data entered by the users for the actions;
storing the entry data in a training data database;
scoring the users based on correct entries of the users.

20. A non-transitory computer-readable recording medium for storing a computer program that when executed on a computer causes information processing, comprising:
providing a training platform to allow a plurality users of an organization to access gamified interactive training simulation;
establishing a user profile for a user;
providing the user with the gamified interactive training simulation for a Graphic User Interface (“GUI”), the training simulation including at least one challenge task, each challenge task including a plurality of actions requiring correct data input from a user for each action for the challenge task to be completed successfully, wherein challenge task includes actions for training a user to use a business application;
recording entry input data entered by the users for the actions;
storing the entry data in a training data database;
scoring the users based on correct entries of the users.
